(19) United States
(12) Patent Application Publication
(10) Pub. No.: US 2026/0369284 A1
(43) Pub. Date: Nov. 19, 2026

(54) COMBINED INPUT FORMAT SPATIAL AUDIO ENCODING

(71) Applicant: NOKIA TECHNOLOGIES OY, Espoo (FI)

(72) Inventor: Adriana VASILACHE, Tampere (FI)

(21) Appl. No.: 19/158,816

(22) PCT Filed: Feb. 1, 2024
(86) PCT No.: PCT/EP2024/052439

§ 371 Date: Aug. 21, 2025

(30) Foreign Application Priority Data
Feb. 24, 2023 (GB) 2302711.3

(51) Int. Cl. G10L 19/035

(52) U.S. Cl. CPC G10L 19/035

(57) ABSTRACT

An apparatus for encoding audio object parameters, the apparatus comprising means for: identifying one of at least two audio objects within an audio environment to be encoded separately; obtaining, for time-frequency elements of a frame comprising at least one time element and at least one frequency element, ratio parameters for the at least two audio objects; grouping, for the time-frequency elements, ratio parameters associated with the at least two audio objects, quantizing the ratio parameters within the grouping, wherein the quantizing the ratio parameter is configured to generate integer representations of the ratio parameter values which sum for a specific grouping to a defined integer value; encoding the integer representations of the ratio parameter values within a first grouping as enumeration indexes; encoding subsequent groupings as difference values with respect to the first grouping.

### FIELD

The present application relates to apparatus and methods for combined input format spatial audio encoding, but not exclusively for combined metadata assisted spatial audio and object input format parameters.

### BACKGROUND

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

The stereo signal could be encoded, for example, with an AAC encoder and the mono signal could be encoded with an EVS encoder. A decoder can decode the audio signals into PCM signals and process the sound in frequency bands (using the spatial metadata) to obtain the spatial output, for example a binaural output.

The aforementioned immersive audio codecs are particularly suitable for encoding captured spatial sound from microphone arrays (e.g., in mobile phones, VR cameras, stand-alone microphone arrays). However, such an encoder can have other input types, for example, loudspeaker signals, audio object signals, Ambisonic signals.

### SUMMARY

According to a first aspect there is provided an apparatus for encoding an audio object parameters, the apparatus comprising means for: identifying one of at least two audio objects within an audio environment to be encoded separately; obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element; grouping, for the time-frequency elements, ratio parameters associated with the at least two audio objects, quantizing the ratio parameters within the grouping, wherein the quantizing the ratio parameter is configured to generate integer representations of the ratio parameter values which sum for a specific grouping to a defined integer value; encoding the integer representations of the ratio parameter values within a first grouping or first set of groupings as enumeration indexes; encoding subsequent groupings as difference values with respect to the first grouping or first set of groupings, wherein the means for encoding subsequent groupings is further for: selecting a sub-set of the integer representations of the ratio parameter values for the subsequent groupings; and encoding the selected sub-set of the integer representations of the ratio parameter value for the subsequent groupings as difference values with respect to the first grouping or first set of groupings, wherein the means for grouping is for ordering the ratio parameters within the grouping such that the selected sub-set of the integer representations of the ratio parameter value comprises the integer representations of the ratio parameter value associated with the selected one of the at least two audio objects to be encoded separately.

The means for selecting a sub-set of the integer representations of the ratio parameter values for the subsequent groupings may be for selecting all but one of the integer representations for a specific grouping, as the integer representations of the ratio parameter values for the grouping is a defined value for every grouping.

The means for encoding the selected sub-set of the integer representations of the ratio parameter value for the subsequent groupings as difference values with respect to the first grouping or first set of groupings may be for: determining that the integer representation of the ratio parameter value corresponding to the one of at least two audio objects within an audio environment to be encoded separately is zero for all frequency elements of the first time element; and encoding all but two of the integer representations for a specific grouping, wherein the encoding does not include the integer representation of the ratio parameter value corresponding to the one of at least two audio objects within an audio environment to be encoded separately when the integer representation of the ratio parameter value corresponding to the one of at least two audio objects within an audio environment to be encoded separately is zero for all frequency elements of the first time element.

The means for selecting a sub-set of the integer representations of the ratio parameter values for the subsequent groupings may be for: determining that the integer representation of the ratio parameter value corresponding to the one of at least two audio objects within an audio environment to be encoded separately is zero for all frequency elements of the first time element; and selecting all but two of the integer representations for a specific grouping, wherein the selecting does not include the integer representation of the ratio parameter value corresponding to the one of at least two audio objects within an audio environment to be encoded separately.

The means for encoding the integer representations of the ratio parameter values within a first grouping or first set of groupings as enumeration indexes may be for generating integer values based on an indexing from the grouping, wherein the generated integer value represents the ratio parameters for the audio objects.

The means for quantizing the ratio parameters within the grouping, wherein the quantizing the ratio parameter is configured to generate integer representations of the ratio parameter values which sum for a specific grouping to a defined integer value may be for: generating a single number value by appending elements from the grouping of ratio parameters; and generating the integer representation from the single number, by performing an iteration loop from a zeroth iteration up to and including the single number of iterations and sequentially associating index values to iteration loop iteration numbers which have a valid selection of ratio parameters, wherein the integer value is the highest index value.

The means for quantizing the ratio parameters within the grouping may be for: quantizing, using a lowest nearest neighbour scalar quantization, ratio values within a specific selection to obtain quantization index values; calculating reconstructed values of the ratio parameters for the specific selection; calculating an error value based on the difference between the reconstructed ratio values and the specific selection of ratio parameter values; determining a sum of quantized index values; and selecting at least one quantized index value to increment such that the sum of quantized index values is equal to an expected index sum.

The means for selecting at least one quantized index value to increment such that the sum of quantized index values is equal to an expected index sum may be for one of: selecting the at least one quantized index value to increment based on identifying a greatest decrease within the error value when the index value is incremented; or selecting the at least one quantized index value to increment based on identifying a minimum increase within the error value when the index value is incremented.

The means for encoding the selected sub-set of the integer representations of the ratio parameter value for the subsequent groupings as difference values with respect to the first grouping or first set of groupings may be for: performing with respect to selected sub-set of the integer representations of the ratio parameter value for the subsequent groupings with respect to a specific time element of the frame: determining a number of bits required for entropy coding differences between the quantized frequency elements for a first and second entropy coding parameters; determining a number of bits required for entropy coding differences between the quantized time elements for the first and second entropy coding parameters; selecting, for the specific time element, the first entropy coding parameter or the second entropy coding parameter based on a smaller number of bits required for coding the differences in the specific time element of the frame; selecting one of the entropy coding of the differences between frequency elements or time elements for the selected first entropy coding parameter or the second entropy coding parameter based entropy coding based on a smaller number of bits required for coding the differences in the specific time element of the frame.

The means for encoding the selected sub-set of the integer representations of the ratio parameter value for the subsequent groupings as difference values with respect to the first grouping or first set of groupings may be for encoding the selected one of the entropy coding of the differences between frequency elements or time elements for the selected first entropy coding parameter or the second entropy coding parameter based entropy coding.

The means for encoding the selected sub-set of the integer representations of the ratio parameter value for the subsequent groupings as difference values with respect to the first grouping or first set of groupings may be for: performing with respect to a set of selection of ratio parameters with respect to a specific frequency element of the frame: determining a number of bits required for the entropy coding quantized differences between frequency elements for a first and second entropy coding parameters; determining a number of bits required entropy coding quantized differences between time elements for the first and second entropy coding parameters; selecting, for the specific frequency element, the first entropy coding parameter or the second entropy coding parameter based on a smaller number of bits required for coding the differences in the specific time element of the frame; selecting, for the specific frequency element, one of the entropy coding of differences between frequency elements or time elements for the selected first entropy coding parameter or the second entropy coding parameter based entropy coding based on a smaller number of bits required for coding the differences in the specific time element of the frame.

The means for encoding the selected sub-set of the integer representations of the ratio parameter value for the subsequent groupings as difference values with respect to the first grouping or first set of groupings may be for encoding the selected one of the entropy coding of the differences between frequency elements or time elements for the selected first entropy coding parameter or the second entropy coding parameter based entropy coding.

The means for encoding the selected sub-set of the integer representations of the ratio parameter value for the subsequent groupings as difference values with respect to the first grouping or first set of groupings may be for: generating an indicator indicating the selected first entropy coding parameter or the second entropy coding parameter; and generating an indicator indicating the selected one of the entropy coding of differences between frequency elements or time elements for the selected first entropy coding parameter or the second entropy coding parameter based entropy coding.

The entropy coding may be Golomb-Rice entropy coding and the first entropy coding parameter may be a Golomb-Rice entropy coding order 0 and the second entropy coding parameter may be a Golomb-Rice entropy coding order 1. The means for encoding the selected sub-set of the integer representations of the ratio parameter value for the subsequent groupings as difference values with respect to the first grouping or first set of groupings may be for differential encoding of the selection of ratio parameters based on the precedingly indexed time element grouping of ratio parameters where there is no precedingly indexed frequency element grouping of ratio parameters.

The ratio parameters configured to identify a distribution of a specific object within the object part of the total audio environment may be ISM ratios.

The means for selecting a sub-set of the integer representations of the ratio parameter values for the subsequent groupings may be further for: determining the integer representations of the ratio parameter value associated with the selected one of the at least two audio objects to be encoded separately is substantially zero for all frequency elements of the first grouping or first set of groupings; and encoding only the remaining selected sub-set of the integer representations of the ratio parameter value for the subsequent groupings as difference values with respect to the first grouping or first set of groupings.

The first grouping may be a grouping of a first time and frequency element of the groupings and the first set of groupings are groupings of frequency element groupings associated with the first time element.

The means may be further for encoding the identified one of the at least two audio objects separately.

According to a second aspect there is provided an apparatus for decoding audio object parameters, the apparatus comprising means for: obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element; identifying one of at least two audio objects within the audio environment has been encoded separately; decoding enumeration indexes within a first grouping or first set of groupings to generate decoded integer representations of the ratio parameter values for the first grouping or first set of groupings; decoding subsequent groupings as difference values with respect to the first grouping or first set of groupings, wherein the means for decoding subsequent groupings is further for: determining with respect to the subsequent groupings a further ratio parameter value based on a difference between a defined total ratio value and a sum of the ratio values within the grouping.

The means for decoding subsequent groupings as difference values with respect to the first grouping or first set of groupings may be further for: determining that the ratio parameter value corresponding to the one of at least two audio objects within an audio environment encoded separately is zero for all frequency elements of the first time element; and determining with respect to the subsequent groupings an additional ratio parameter value with a value of zero representing the one of at least two audio objects within an audio environment encoded separately.

The grouping may be a vector of the ratio parameters.

The means for decoding enumeration indexes within a first grouping or first set of groupings to generate decoded integer representations of the ratio parameter values for the first grouping or first set of groupings is for: obtaining an integer value representing encoded ratio parameters; converting the integer value to a selection of ratio parameters based on the indexing of the vector; and regenerating at least one further ratio parameter from the selection of the ratio parameters.

The means for decoding subsequent groupings as difference values with respect to the first grouping or first set of groupings may be for: obtaining a difference indicator identifying a frequency difference or time difference encoding; obtaining an entropy encoding indicator identifying an entropy encoding parameter; decoding the remaining selection of the ratio parameters for the frame based on the difference indicator and the entropy encoding indicator.

The ratio parameters configured to identify a distribution of a specific object within the object part of the total audio environment may be ISM ratios.

According to a third aspect there is provided a method for encoding an audio object parameters, the method comprising: identifying one of at least two audio objects within an audio environment to be encoded separately; obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element; grouping, for the time-frequency elements, ratio parameters associated with the at least two audio objects, quantizing the ratio parameters within the grouping, wherein the quantizing the ratio parameter is configured to generate integer representations of the ratio parameter values which sum for a specific grouping to a defined integer value; encoding the integer representations of the ratio parameter values within a first grouping or first set of groupings as enumeration indexes; encoding subsequent groupings as difference values with respect to the first grouping or first set of groupings, wherein the means for encoding subsequent groupings is further for: selecting a sub-set of the integer representations of the ratio parameter values for the subsequent groupings; and encoding the selected sub-set of the integer representations of the ratio parameter value for the subsequent groupings as difference values with respect to the first grouping or first set of groupings, wherein the means for grouping is for ordering the ratio parameters within the grouping such that the selected sub-set of the integer representations of the ratio parameter value comprises the integer representations of the ratio parameter value associated with the selected one of the at least two audio objects to be encoded separately.

Selecting a sub-set of the integer representations of the ratio parameter values for the subsequent groupings may comprise selecting all but one of the integer representations for a specific grouping, as the integer representations of the ratio parameter values for the grouping is a defined value for every grouping.

Encoding the selected sub-set of the integer representations of the ratio parameter value for the subsequent groupings as difference values with respect to the first grouping or first set of groupings may comprise: determining that the integer representation of the ratio parameter value corresponding to the one of at least two audio objects within an audio environment to be encoded separately is zero for all frequency elements of the first time element; and encoding all but two of the integer representations for a specific grouping, wherein the encoding does not include the integer representation of the ratio parameter value corresponding to the one of at least two audio objects within an audio environment to be encoded separately when the integer representation of the ratio parameter value corresponding to the one of at least two audio objects within an audio environment to be encoded separately is zero for all frequency elements of the first time element.

Selecting a sub-set of the integer representations of the ratio parameter values for the subsequent groupings may comprise: determining that the integer representation of the ratio parameter value corresponding to the one of at least two audio objects within an audio environment to be encoded separately is zero for all frequency elements of the first time element; and selecting all but two of the integer representations for a specific grouping, wherein the selecting does not include the integer representation of the ratio parameter value corresponding to the one of at least two audio objects within an audio environment to be encoded separately.

Encoding the integer representations of the ratio parameter values within a first grouping or first set of groupings as enumeration indexes may comprise generating integer values based on an indexing from the grouping, wherein the generated integer value represents the ratio parameters for the audio objects.

Quantizing the ratio parameters within the grouping may comprise: generating a single number value by appending elements from the grouping of ratio parameters; and generating the integer representation from the single number, by performing an iteration loop from a zeroth iteration up to and including the single number of iterations and sequentially associating index values to iteration loop iteration numbers which have a valid selection of ratio parameters, wherein the integer value is the highest index value.

Quantizing the ratio parameters within the grouping may comprise: quantizing, using a lowest nearest neighbour scalar quantization, ratio values within a specific selection to obtain quantization index values; calculating reconstructed values of the ratio parameters for the specific selection; calculating an error value based on the difference between the reconstructed ratio values and the specific selection of ratio parameter values; determining a sum of quantized index values; and selecting at least one quantized index value to increment such that the sum of quantized index values is equal to an expected index sum.

Selecting at least one quantized index value to increment such that the sum of quantized index values is equal to an expected index sum may comprise one of: selecting the at least one quantized index value to increment based on identifying a greatest decrease within the error value when the index value is incremented; or selecting the at least one quantized index value to increment based on identifying a minimum increase within the error value when the index value is incremented.

Encoding the selected sub-set of the integer representations of the ratio parameter value for the subsequent groupings as difference values with respect to the first grouping or first set of groupings may comprise: performing with respect to selected sub-set of the integer representations of the ratio parameter value for the subsequent groupings with respect to a specific time element of the frame: determining a number of bits required for entropy coding differences between the quantized frequency elements for a first and second entropy coding parameters; determining a number of bits required for entropy coding differences between the quantized time elements for the first and second entropy coding parameters; selecting, for the specific time element, the first entropy coding parameter or the second entropy coding parameter based on a smaller number of bits required for coding the differences in the specific time element of the frame; selecting one of the entropy coding of the differences between frequency elements or time elements for the selected first entropy coding parameter or the second entropy coding parameter based entropy coding based on a smaller number of bits required for coding the differences in the specific time element of the frame.

Encoding the selected sub-set of the integer representations of the ratio parameter value for the subsequent groupings as difference values with respect to the first grouping or first set of groupings may comprise encoding the selected one of the entropy coding of the differences between frequency elements or time elements for the selected first entropy coding parameter or the second entropy coding parameter based entropy coding.

Encoding the selected sub-set of the integer representations of the ratio parameter value for the subsequent groupings as difference values with respect to the first grouping or first set of groupings may comprise: performing with respect to a set of selection of ratio parameters with respect to a specific frequency element of the frame: determining a number of bits required entropy coding quantized differences between frequency elements for a first and second entropy coding parameters; determining a number of bits required entropy coding quantized differences between time elements for the first and second entropy coding parameters; selecting, for the specific frequency element, the first entropy coding parameter or the second entropy coding parameter based on a smaller number of bits required for coding the differences in the specific time element of the frame; selecting, for the specific frequency element, one of the entropy coding of differences between frequency elements or time elements for the selected first entropy coding parameter or the second entropy coding parameter based entropy coding based on a smaller number of bits required for coding the differences in the specific time element of the frame.

Encoding the selected sub-set of the integer representations of the ratio parameter value for the subsequent groupings as difference values with respect to the first grouping or first set of groupings may comprise encoding the selected one of the entropy coding of the differences between frequency elements or time elements for the selected first entropy coding parameter or the second entropy coding parameter based entropy coding.

Encoding the selected sub-set of the integer representations of the ratio parameter value for the subsequent groupings as difference values with respect to the first grouping or first set of groupings may comprise: generating an indicator indicating the selected first entropy coding parameter or the second entropy coding parameter; and generating an indicator indicating the selected one of the entropy coding of differences between frequency elements or time elements for the selected first entropy coding parameter or the second entropy coding parameter based entropy coding.

The entropy coding may be Golomb-Rice entropy coding and the first entropy coding parameter may be a Golomb-Rice entropy coding order 0 and the second entropy coding parameter may be a Golomb-Rice entropy coding order 1.

Encoding the selected sub-set of the integer representations of the ratio parameter value for the subsequent groupings as difference values with respect to the first grouping or first set of groupings may comprise differential encoding of the selection of ratio parameters based on the precedingly indexed time element grouping of ratio parameters where there is no precedingly indexed frequency element grouping of ratio parameters.

The ratio parameters configured to identify a distribution of a specific object within the object part of the total audio environment may be ISM ratios.

Selecting a sub-set of the integer representations of the ratio parameter values for the subsequent groupings may comprise: determining the integer representations of the ratio parameter value associated with the selected one of the at least two audio objects to be encoded separately is substantially zero for all frequency elements of the first grouping or first set of groupings; and encoding only the remaining selected sub-set of the integer representations of the ratio parameter value for the subsequent groupings as difference values with respect to the first grouping or first set of groupings.

The first grouping may be a grouping of a first time and frequency element of the groupings and the first set of groupings are groupings of frequency element groupings associated with the first time element.

The method may further comprise encoding the identified one of the at least two audio objects separately.

According to a fourth aspect there is provided a method for an apparatus for decoding audio object parameters, the method comprising: obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element; identifying one of at least two audio objects within the audio environment has been encoded separately; decoding enumeration indexes within a first grouping or first set of groupings to generate decoded integer representations of the ratio parameter values for the first grouping or first set of groupings; decoding subsequent groupings as difference values with respect to the first grouping or first set of groupings, wherein the means for decoding subsequent groupings is further for: determining with respect to the subsequent groupings a further ratio parameter value based on a difference between a defined total ratio value and a sum of the ratio values within the grouping.

Decoding subsequent groupings as difference values with respect to the first grouping or first set of groupings may further comprise: determining that the ratio parameter value corresponding to the one of at least two audio objects within an audio environment encoded separately is zero for all frequency elements of the first time element; and determining with respect to the subsequent groupings an additional ratio parameter value with a value of zero representing the one of at least two audio objects within an audio environment encoded separately.

The grouping may be a vector of the ratio parameters.

Decoding enumeration indexes within a first grouping or first set of groupings to generate decoded integer representations of the ratio parameter values for the first grouping or first set of groupings may comprise: obtaining an integer value representing encoded ratio parameters; converting the integer value to a selection of ratio parameters based on the indexing of the vector; and regenerating at least one further ratio parameter from the selection of the ratio parameters.

Decoding subsequent groupings as difference values with respect to the first grouping or first set of groupings may comprise: obtaining a difference indicator identifying a frequency difference or time difference encoding; obtaining an entropy encoding indicator identifying an entropy encoding parameter; decoding the remaining selection of the ratio parameters for the frame based on the difference indicator and the entropy encoding indicator.

The ratio parameters configured to identify a distribution of a specific object within the object part of the total audio environment may be ISM ratios.

According to a fifth aspect there is provided an apparatus for encoding audio object parameters, the apparatus comprising at least one processor and at least one memory storing instructions that, when executed by the at least one processor, cause the system at least to perform: identifying one of at least two audio objects within an audio environment to be encoded separately; obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element; grouping, for the time-frequency elements, ratio parameters associated with the at least two audio objects, quantizing the ratio parameters within the grouping, wherein the quantizing the ratio parameter is configured to generate integer representations of the ratio parameter values which sum for a specific grouping to a defined integer value; encoding the integer representations of the ratio parameter values within a first grouping or first set of groupings as enumeration indexes; encoding subsequent groupings as difference values with respect to the first grouping or first set of groupings, wherein the means for encoding subsequent groupings is further for: selecting a sub-set of the integer representations of the ratio parameter values for the subsequent groupings; and encoding the selected sub-set of the integer representations of the ratio parameter value for the subsequent groupings as difference values with respect to the first grouping or first set of groupings, wherein the means for grouping is for ordering the ratio parameters within the grouping such that the selected sub-set of the integer representations of the ratio parameter value comprises the integer representations of the ratio parameter value associated with the selected one of the at least two audio objects to be encoded separately.

The apparatus caused to perform selecting a sub-set of the integer representations of the ratio parameter values for the subsequent groupings may be caused to perform selecting all but one of the integer representations for a specific grouping, as the integer representations of the ratio parameter values for the grouping is a defined value for every grouping.

The apparatus caused to perform encoding the selected sub-set of the integer representations of the ratio parameter value for the subsequent groupings as difference values with respect to the first grouping or first set of groupings may be caused to perform: determining that the integer representation of the ratio parameter value corresponding to the one of at least two audio objects within an audio environment to be encoded separately is zero for all frequency elements of the first time element; and encoding all but two of the integer representations for a specific grouping, wherein the encoding does not include the integer representation of the ratio parameter value corresponding to the one of at least two audio objects within an audio environment to be encoded separately when the integer representation of the ratio parameter value corresponding to the one of at least two audio objects within an audio environment to be encoded separately is zero for all frequency elements of the first time element.

The apparatus caused to perform selecting a sub-set of the integer representations of the ratio parameter values for the subsequent groupings may be caused to perform: determining that the integer representation of the ratio parameter value corresponding to the one of at least two audio objects within an audio environment to be encoded separately is zero for all frequency elements of the first time element; and selecting all but two of the integer representations for a specific grouping, wherein the selecting does not include the integer representation of the ratio parameter value corresponding to the one of at least two audio objects within an audio environment to be encoded separately.

The apparatus caused to perform encoding the integer representations of the ratio parameter values within a first grouping or first set of groupings as enumeration indexes may be caused to perform generating integer values based on an indexing from the grouping, wherein the generated integer value represents the ratio parameters for the audio objects.

The apparatus caused to perform quantizing the ratio parameters within the grouping, wherein the quantizing the ratio parameter is configured to generate integer representations of the ratio parameter values which sum for a specific grouping to a defined integer value may be caused to perform: generating a single number value by appending elements from the grouping of ratio parameters; and generating the integer representation from the single number, by performing an iteration loop from a zeroth iteration up to and including the single number of iterations and sequentially associating index values to iteration loop iteration numbers which have a valid selection of ratio parameters, wherein the integer value is the highest index value.

The apparatus caused to perform quantizing the ratio parameters within the grouping may be caused to perform: quantizing, using a lowest nearest neighbour scalar quantization, ratio values within a specific selection to obtain quantization index values; calculating reconstructed values of the ratio parameters for the specific selection; calculating an error value based on the difference between the reconstructed ratio values and the specific selection of ratio parameter values; determining a sum of quantized index values; and selecting at least one quantized index value to increment such that the sum of quantized index values is equal to an expected index sum.

The apparatus caused to perform selecting at least one quantized index value to increment such that the sum of quantized index values is equal to an expected index sum may be caused to perform: selecting the at least one quantized index value to increment based on identifying a greatest decrease within the error value when the index value is incremented; or selecting the at least one quantized index value to increment based on identifying a minimum increase within the error value when the index value is incremented.

The apparatus caused to perform encoding the selected sub-set of the integer representations of the ratio parameter value for the subsequent groupings as difference values with respect to the first grouping or first set of groupings may be caused to perform with respect to selected sub-set of the integer representations of the ratio parameter value for the subsequent groupings with respect to a specific time element of the frame: determining a number of bits required for entropy coding differences between the quantized frequency elements for a first and second entropy coding parameters; determining a number of bits required for entropy coding differences between the quantized time elements for the first and second entropy coding parameters; selecting, for the specific time element, the first entropy coding parameter or the second entropy coding parameter based on a smaller number of bits required for coding the differences in the specific time element of the frame; selecting one of the entropy coding of the differences between frequency elements or time elements for the selected first entropy coding parameter or the second entropy coding parameter based entropy coding based on a smaller number of bits required for coding the differences in the specific time element of the frame.

The apparatus caused to perform encoding the selected sub-set of the integer representations of the ratio parameter value for the subsequent groupings as difference values with respect to the first grouping or first set of groupings may be caused to perform encoding the selected one of the entropy coding of the differences between frequency elements or time elements for the selected first entropy coding parameter or the second entropy coding parameter based entropy coding.

The apparatus caused to perform encoding the selected sub-set of the integer representations of the ratio parameter value for the subsequent groupings as difference values with respect to the first grouping or first set of groupings may be caused to perform with respect to a set of selection of ratio parameters with respect to a specific frequency element of the frame: determining a number of bits required entropy coding quantized differences between frequency elements for a first and second entropy coding parameters; determining a number of bits required entropy coding quantized differences between time elements for the first and second entropy coding parameters; selecting, for the specific frequency element, the first entropy coding parameter or the second entropy coding parameter based on a smaller number of bits required for coding the differences in the specific time element of the frame; selecting, for the specific frequency element, one of the entropy coding of differences between frequency elements or time elements for the selected first entropy coding parameter or the second entropy coding parameter based entropy coding based on a smaller number of bits required for coding the differences in the specific time element of the frame.

The apparatus caused to perform encoding the selected sub-set of the integer representations of the ratio parameter value for the subsequent groupings as difference values with respect to the first grouping or first set of groupings may be caused to perform encoding the selected one of the entropy coding of the differences between frequency elements or time elements for the selected first entropy coding parameter or the second entropy coding parameter based entropy coding.

The apparatus caused to perform encoding the selected sub-set of the integer representations of the ratio parameter value for the subsequent groupings as difference values with respect to the first grouping or first set of groupings may be caused to perform: generating an indicator indicating the selected first entropy coding parameter or the second entropy coding parameter; and generating an indicator indicating the selected one of the entropy coding of differences between frequency elements or time elements for the selected first entropy coding parameter or the second entropy coding parameter based entropy coding.

The entropy coding may be Golomb-Rice entropy coding and the first entropy coding parameter may be a Golomb-Rice entropy coding order 0 and the second entropy coding parameter may be a Golomb-Rice entropy coding order 1.

The apparatus caused to perform encoding the selected sub-set of the integer representations of the ratio parameter value for the subsequent groupings as difference values with respect to the first grouping or first set of groupings may be caused to perform differential encoding of the selection of ratio parameters based on the precedingly indexed time element grouping of ratio parameters where there is no precedingly indexed frequency element grouping of ratio parameters.

The ratio parameters configured to identify a distribution of a specific object within the object part of the total audio environment may be ISM ratios.

The apparatus caused to perform selecting a sub-set of the integer representations of the ratio parameter values for the subsequent groupings may be further caused to perform: determining the integer representations of the ratio parameter value associated with the selected one of the at least two audio objects to be encoded separately is substantially zero for all frequency elements of the first grouping or first set of groupings; and encoding only the remaining selected sub-set of the integer representations of the ratio parameter value for the subsequent groupings as difference values with respect to the first grouping or first set of groupings.

The first grouping may be a grouping of a first time and frequency element of the groupings and the first set of groupings are groupings of frequency element groupings associated with the first time element.

The apparatus may be further caused to perform encoding the identified one of the at least two audio objects separately.

According to a sixth aspect there is provided an apparatus for decoding audio object parameters, the apparatus comprising at least one processor and at least one memory storing instructions that, when executed by the at least one processor, cause the system at least to perform: obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element; identifying one of at least two audio objects within the audio environment has been encoded separately; decoding enumeration indexes within a first grouping or first set of groupings to generate decoded integer representations of the ratio parameter values for the first grouping or first set of groupings; decoding subsequent groupings as difference values with respect to the first grouping or first set of groupings, wherein the means for decoding subsequent groupings is further for: determining with respect to the subsequent groupings a further ratio parameter value based on a difference between a defined total ratio value and a sum of the ratio values within the grouping.

The apparatus caused to perform decoding subsequent groupings as difference values with respect to the first grouping or first set of groupings may be further caused to perform: determining that the ratio parameter value corresponding to the one of at least two audio objects within an audio environment encoded separately is zero for all frequency elements of the first time element; and determining with respect to the subsequent groupings an additional ratio parameter value with a value of zero representing the one of at least two audio objects within an audio environment encoded separately.

The grouping may be a vector of the ratio parameters.

The apparatus caused to perform decoding enumeration indexes within a first grouping or first set of groupings to generate decoded integer representations of the ratio parameter values for the first grouping or first set of groupings is further caused to perform: obtaining an integer value representing encoded ratio parameters; converting the integer value to a selection of ratio parameters based on the indexing of the vector; and regenerating at least one further ratio parameter from the selection of the ratio parameters.

The apparatus caused to perform decoding subsequent groupings as difference values with respect to the first grouping or first set of groupings may be further caused to perform: obtaining a difference indicator identifying a frequency difference or time difference encoding; obtaining an entropy encoding indicator identifying an entropy encoding parameter; decoding the remaining selection of the ratio parameters for the frame based on the difference indicator and the entropy encoding indicator.

The ratio parameters configured to identify a distribution of a specific object within the object part of the total audio environment may be ISM ratios.

According to a seventh aspect there is provided an apparatus for encoding audio object parameters, the apparatus comprising: identifying circuitry configured to identify one of at least two audio objects within an audio environment to be encoded separately; obtaining circuitry configured to obtain, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element; grouping circuitry configured to group, for the time-frequency elements, ratio parameters associated with the at least two audio objects, quantizing the ratio parameters within the grouping, wherein the quantizing the ratio parameter is configured to generate integer representations of the ratio parameter values which sum for a specific grouping to a defined integer value; encoding circuitry configured to encode the integer representations of the ratio parameter values within a first grouping or first set of groupings as enumeration indexes; encoding circuitry configured to encode subsequent groupings as difference values with respect to the first grouping or first set of groupings, wherein the means for encoding subsequent groupings is further for: selecting circuitry configured to select a sub-set of the integer representations of the ratio parameter values for the subsequent groupings; and encoding circuitry configured to encode the selected sub-set of the integer representations of the ratio parameter value for the subsequent groupings as difference values with respect to the first grouping or first set of groupings, wherein the grouping is for ordering the ratio parameters within the grouping such that the selected sub-set of the integer representations of the ratio parameter value comprises the integer representations of the ratio parameter value associated with the selected one of the at least two audio objects to be encoded separately.

According to an eighth aspect there is provided an apparatus for decoding audio object parameters, the apparatus comprising: obtaining circuitry configured to obtain a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element; identifying circuitry configured to identify one of at least two audio objects within the audio environment has been encoded separately; decoding circuitry configured to decode enumeration indexes within a first grouping or first set of groupings to generate decoded integer representations of the ratio parameter values for the first grouping or first set of groupings; decoding circuitry configured to decode subsequent groupings as difference values with respect to the first grouping or first set of groupings, wherein the decoding subsequent groupings further comprises: determining with respect to the subsequent groupings a further ratio parameter value based on a difference between a defined total ratio value and a sum of the ratio values within the grouping.

According to a ninth aspect there is provided a computer program comprising instructions [or a computer readable medium comprising program instructions] for causing an apparatus for encoding an audio object parameter to perform at least the following: identifying one of at least two audio objects within an audio environment to be encoded separately; obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element; grouping, for the time-frequency elements, ratio parameters associated with the at least two audio objects, quantizing the ratio parameters within the grouping, wherein the quantizing the ratio parameter is configured to generate integer representations of the ratio parameter values which sum for a specific grouping to a defined integer value; encoding the integer representations of the ratio parameter values within a first grouping or first set of groupings as enumeration indexes; encoding subsequent groupings as difference values with respect to the first grouping or first set of groupings, wherein encoding subsequent groupings further comprises selecting a sub-set of the integer representations of the ratio parameter values for the subsequent groupings; and encoding the selected sub-set of the integer representations of the ratio parameter value for the subsequent groupings as difference values with respect to the first grouping or first set of groupings, wherein grouping comprises ordering the ratio parameters within the grouping such that the selected sub-set of the integer representations of the ratio parameter value comprises the integer representations of the ratio parameter value associated with the selected one of the at least two audio objects to be encoded separately. According to a tenth aspect there is provided a computer program comprising instructions [or a computer readable medium comprising program instructions] for causing an apparatus for decoding an audio object parameter to perform at least the following: obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element; identifying one of at least two audio objects within the audio environment has been encoded separately; decoding enumeration indexes within a first grouping or first set of groupings to generate decoded integer representations of the ratio parameter values for the first grouping or first set of groupings; decoding subsequent groupings as difference values with respect to the first grouping or first set of groupings, wherein decoding subsequent groupings further comprises: determining with respect to the subsequent groupings a further ratio parameter value based on a difference between a defined total ratio value and a sum of the ratio values within the grouping.

According to an eleventh aspect there is provided a non-transitory computer readable medium comprising program instructions for causing an apparatus for encoding an audio object parameter to perform at least the following: identifying one of at least two audio objects within an audio environment to be encoded separately; obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element; grouping, for the time-frequency elements, ratio parameters associated with the at least two audio objects, quantizing the ratio parameters within the grouping, wherein the quantizing the ratio parameter is configured to generate integer representations of the ratio parameter values which sum for a specific grouping to a defined integer value; encoding the integer representations of the ratio parameter values within a first grouping or first set of groupings as enumeration indexes; encoding subsequent groupings as difference values with respect to the first grouping or first set of groupings, wherein the encoding subsequent groupings further comprises: selecting a sub-set of the integer representations of the ratio parameter values for the subsequent groupings; and encoding the selected sub-set of the integer representations of the ratio parameter value for the subsequent groupings as difference values with respect to the first grouping or first set of groupings, wherein grouping comprises ordering the ratio parameters within the grouping such that the selected sub-set of the integer representations of the ratio parameter value comprises the integer representations of the ratio parameter value associated with the selected one of the at least two audio objects to be encoded separately.

According to a twelfth aspect there is provided a non-transitory computer readable medium comprising program instructions for causing an apparatus for decoding an audio object parameter to perform at least the following: obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element; identifying one of at least two audio objects within the audio environment has been encoded separately; decoding enumeration indexes within a first grouping or first set of groupings to generate decoded integer representations of the ratio parameter values for the first grouping or first set of groupings; decoding subsequent groupings as difference values with respect to the first grouping or first set of groupings, wherein decoding subsequent groupings further comprises: determining with respect to the subsequent groupings a further ratio parameter value based on a difference between a defined total ratio value and a sum of the ratio values within the grouping.

According to a thirteenth aspect there is provided an apparatus for encoding an audio object parameter, the apparatus comprising: means for identifying one of at least two audio objects within an audio environment to be encoded separately; means for obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element; grouping, for the time-frequency elements, ratio parameters associated with the at least two audio objects, means for quantizing the ratio parameters within the grouping, wherein the quantizing the ratio parameter is configured to generate integer representations of the ratio parameter values which sum for a specific grouping to a defined integer value; means for encoding the integer representations of the ratio parameter values within a first grouping or first set of groupings as enumeration indexes; means for encoding subsequent groupings as difference values with respect to the first grouping or first set of groupings, wherein the means for encoding subsequent groupings further comprises: means for selecting a sub-set of the integer representations of the ratio parameter values for the subsequent groupings; and means for encoding the selected sub-set of the integer representations of the ratio parameter value for the subsequent groupings as difference values with respect to the first grouping or first set of groupings, wherein the means for grouping comprises means for ordering the ratio parameters within the grouping such that the selected sub-set of the integer representations of the ratio parameter value comprises the integer representations of the ratio parameter value associated with the selected one of the at least two audio objects to be encoded separately.

According to a fourteenth aspect there is provided an apparatus for decoding an audio object parameter, the apparatus comprising: means for obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element; means for identifying one of at least two audio objects within the audio environment has been encoded separately; means for decoding enumeration indexes within a first grouping or first set of groupings to generate decoded integer representations of the ratio parameter values for the first grouping or first set of groupings; means for decoding subsequent groupings as difference values with respect to the first grouping or first set of groupings, wherein the means for decoding subsequent groupings further comprises: means for determining with respect to the subsequent groupings a further ratio parameter value based on a difference between a defined total ratio value and a sum of the ratio values within the grouping.

According to a fifteenth aspect there is provided a computer readable medium comprising program instructions for causing an apparatus for encoding an audio object parameter to perform at least the following: identifying one of at least two audio objects within an audio environment to be encoded separately; obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element; grouping, for the time-frequency elements, ratio parameters associated with the at least two audio objects, quantizing the ratio parameters within the grouping, wherein the quantizing the ratio parameter is configured to generate integer representations of the ratio parameter values which sum for a specific grouping to a defined integer value; encoding the integer representations of the ratio parameter values within a first grouping or first set of groupings as enumeration indexes; encoding subsequent groupings as difference values with respect to the first grouping or first set of groupings, wherein encoding subsequent groupings further comprises selecting a sub-set of the integer representations of the ratio parameter values for the subsequent groupings; and encoding the selected sub-set of the integer representations of the ratio parameter value for the subsequent groupings as difference values with respect to the first grouping or first set of groupings, wherein grouping comprises ordering the ratio parameters within the grouping such that the selected sub-set of the integer representations of the ratio parameter value comprises the integer representations of the ratio parameter value associated with the selected one of the at least two audio objects to be encoded separately.

According to a sixteenth aspect there is provided a computer readable medium comprising program instructions for causing an apparatus for decoding an audio object parameter to perform at least the following: obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element; identifying one of at least two audio objects within the audio environment has been encoded separately; decoding enumeration indexes within a first grouping or first set of groupings to generate decoded integer representations of the ratio parameter values for the first grouping or first set of groupings; decoding subsequent groupings as difference values with respect to the first grouping or first set of groupings, wherein decoding subsequent groupings further comprises: determining with respect to the subsequent groupings a further ratio parameter value based on a difference between a defined total ratio value and a sum of the ratio values within the grouping.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically an example encoding mode selector as shown in the system of apparatus as shown in FIG. 1 according to some embodiments;

FIG. 3 shows a flow diagram of the operation of the example encoding mode selector shown in FIG. 2 according to some embodiments;

FIG. 4 shows a flow diagram of the operation of the example first, lowest, or only MASA bitrate encoding mode shown in FIG. 3 according to some embodiments;

FIG. 5 shows a flow diagram of the operation of the example second, lower, or object information encoding mode shown in FIG. 3 according to some embodiments;

FIG. 6 shows a flow diagram of the operation of the example third, higher, or single object encoding mode shown in FIG. 3 according to some embodiments;

FIG. 7 shows a flow diagram of the operation of the example fourth, highest, or independent object and multi-input encoding mode shown in FIG. 3 according to some embodiments;

FIG. 8 shows schematically an example audio object metadata encoder as shown in FIG. 1 according to some embodiments;

FIG. 9 shows a flow diagram of the operation of the example audio object analyser and audio object metadata encoder encoding mode selector shown in FIG. 8 according to some embodiments; and

FIG. 10 shows an example device suitable for implementing the apparatus shown in previous figures.

### EMBODIMENTS OF THE APPLICATION

The following describes in further detail suitable apparatus and possible mechanisms for the encoding of parametric spatial audio signals comprising transport audio signals and spatial metadata. As indicated above immersive audio codecs (such as 3GPP IVAS) are being planned which support a multitude of operating points ranging from a low bit rate operation to transparency. It is expected to support channel-based audio, object based, and scene-based audio inputs including spatial information about the sound field and sound sources. In the following the example codec is configured to be able to receive multiple input formats. In particular the codec is configured to obtain or receive a multi audio signal (for example received from a microphone array, or as a multichannel audio format input, or an Ambisonics format input) and an audio object signal (these can also be called an Independent Stream with Metadata—ISM format). Furthermore in some situations the codec is configured to handle more than one input format at a time. This combined (input) format mode can, for example, enable simultaneous encoding of two different audio input formats. An example of two different audio input formats being currently considered is the combination of the MASA format with audio object format.

Metadata-Assisted Spatial Audio (MASA) is an example of a parametric spatial audio format and representation suitable as an input format for IVAS.

It can be considered an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction (or directional value) a direct-to-total energy ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example a reasonable design choice which is able to produce a good quality output is one where the spatial metadata comprises one or more directions for each time-frequency subframe (and associated with each direction direct-to-total ratios, spread coherence, distance values etc) are determined.

Examples of MASA spatial metadata is presented in the following table. These values are available for each time-frequency tile. In some implementations a frame is subdivided into 24 frequency bands and 4 temporal sub-frames. In other implementations other divisions of frequency and time can be employed. Furthermore in some implementations a frame size (for example as implemented in IVAS) is 20 ms (and thus the temporal sub-frame is 5 ins). However, similarly, other frame lengths can be employed in other embodiments. In some embodiments the MASA analyser is configured to determine 1 or 2 directions for each time-frequency tile (i.e., there are 1 or 2 direction index, direct-to-total energy ratio, and spread coherence parameters for each time-frequency tile). However in some embodiments the analyser is configured to generate more than 2 directions for a time-frequency tile.

| Field | bits | Description |
|---|---|---|
| Direction index | 16 | Direction of arrival of the sound at a time- |
| | | frequency parameter interval. Spherical |
| | | representation at about 1-degree accuracy. |
| | | Range of values: “covers all directions at |
| | | about 1° accuracy” |
| | | Values stored as 16-bit unsigned integers. |
| Direct-to-total | 8 | Energy ratio for the direction index (i.e., time- |
| energy ratio | | frequency subframe). |
| | | Calculated as energy in direction/total |
| | | energy. |
| | | Range of values: [0.0, 1.0] |
| | | Values stored as 8-bit unsigned integers with |
| | | uniform spacing of mapped values. |
| Spread | 8 | Spread of energy for the direction index (i.e., |
| coherence | | time-frequency subframe). |
| | | Defines the direction to be reproduced as a |
| | | point source or coherently around the |
| | | direction. |
| | | Range of values: [0.0, 1.0] |
| | | Values stored as 8-bit unsigned integers with |
| | | uniform spacing of mapped values. |
| Diffuse-to-total | 8 | Energy ratio of non-directional sound over |
| energy ratio | | surrounding directions. |
| | | Calculated as energy of non-directional sound/ |
| | | total energy. |
| | | Range of values: [0.0, 1.0] |
| | | (Parameter is independent of number of |
| | | directions provided.) |
| | | Values stored as 8-bit unsigned integers with |
| | | uniform spacing of mapped values. |
| Surround | 8 | Coherence of the non-directional sound over |
| coherence | | the surrounding directions. |
| | | Range of values: [0.0, 1.0] |
| | | (Parameter is independent of number of |
| | | directions provided.) |
| | | Values stored as 8-bit unsigned integers with |
| | | uniform spacing of mapped values. |
| Remainder-to- | 8 | Energy ratio of the remainder (such as |
| total energy | | microphone noise) sound energy to fulfil |
| ratio | | requirement that sum of energy ratios is 1. |
| | | Calculated as energy of remainder sound/ |
| | | total energy. |
| | | Range of values: [0.0, 1.0] |
| | | (Parameter is independent of number of |
| | | directions provided.) |
| | | Values stored as 8-bit unsigned integers with |
| | | uniform spacing of mapped values. |

The MASA stream can be rendered to various outputs, such as multichannel loudspeaker signals (e.g., 5.1) or binaural signals.

Another input format to be supported by IVAS is, as discussed above, the ISM (Independent Streams with Metadata) format. The ISM format is intended for representing individual sound sources (audio objects) in a sound scene with the associated metadata describing how the rendering of the audio signal may be implemented. This can be contrasted to the MASA format where the audio signals and associated metadata describe perceptually the whole sound scene. Example metadata for the ISM format may comprise the following parameters:
Position (e.g., as azimuth, elevation or azimuth, elevation and radius);
Orientation;
Extent/spread;
Distance attenuation; and
Directivity pattern.

In some embodiments some of the example metadata parameters such as the position, orientation, and extent/spread can vary through time but not frequency, whereas some of the parameters, for example, distance attenuation and directivity pattern may vary through frequency but usually do not vary through time. However the parameters can have time and frequency variances (or invariances) other than the examples above and herein.

In some embodiments an ISM format input can be obtained by capturing individual sources in a scene using, for example, close or lavalier microphones (located on or near to an individual source). Examples of such individual sources are: separate speakers in a teleconference, a singer, or individual instruments. Metadata can then be associated to these ISM format signals automatically by, for example, position trackers, or manually by a mixing professional. Alternatively, ISM format signals may be generated by mixing and creating suitable associated metadata. An example of fully generated sound sources is in game audio engines.

As indicated above research is being carried out into enabling the IVAS codec to support combined coding of multiple audio formats.

The combined input format mode will enable simultaneous encoding of two different audio input formats. The first considered example is the combination of the MASA format with the audio objects (i.e., the independent mono streams (ISM) with/without metadata), and it is the topic of following examples. For the transmission of this combined format at mid or middle bitrates, there is a parametric model that includes the ISM energy ratios and they define the fraction of the audio scene created by each object within the audio scene created by all the objects. For each time-frequency tile there is a group of O such values, where O is the number of objects in the scene. There can be a significant amount of such values (e.g., 20×O), and it is therefore important to have efficient encoding of the values.

The examples described herein therefore consider the case where one most significant object is coded separately and the rest of the objects are encoded with the parametric mode.

The current solution proposes, for the one separated object coding mode, an informed transformation of the ISM ratio index vectors prior to coding. The transformation is informed by the index of the separated object. In some examples the embodiments have been shown to reduce the necessary bitrate by up to 15%.

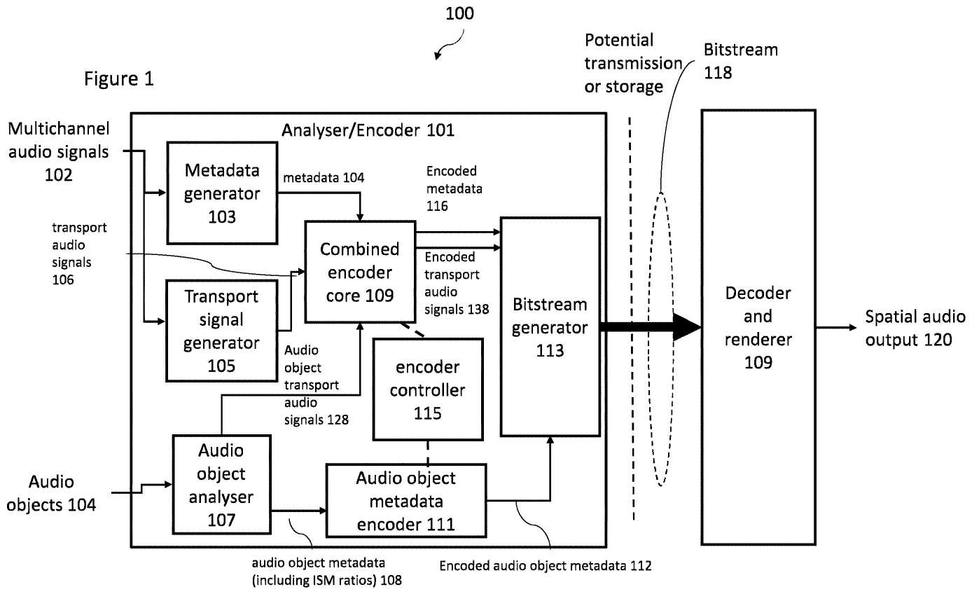

In this regard FIG. 1 depicts an example apparatus 100 and system for implementing embodiments of the application. The system is shown with an analyser/encoder 101. The analyser/encoder 101 is the part from receiving the input signals up to a transmission or storage of an encoded bitstream (comprising a transport audio signal and metadata).

The input to the system analyser/encoder 101 is the multichannel audio signals 102. In the following examples a microphone channel signal input is described, however any suitable input (or synthetic multichannel) format may be implemented in other embodiments. For example, in some embodiments the spatial analyser and the spatial analysis may be implemented external to the encoder. For example, in some embodiments the spatial (MASA) metadata associated with the audio signals may be provided to an encoder as a separate bit-stream. In some embodiments the spatial (MASA) metadata may be provided as a set of spatial (direction) index values.

Additionally, FIG. 1 also depicts multiple audio objects 104 as a further input to the analysis part. As mentioned above these multiple audio objects (or audio object stream) 104 may represent various sound sources within a physical space. Each audio object may be characterized by an audio (object) signal and accompanying metadata comprising directional data (in the form of azimuth and elevation values) which indicate the position or direction of the audio object within a physical space on an audio frame basis.

The multichannel signals 102 are passed to an analyser and encoder 101, and specifically a transport signal generator 105 and to a metadata generator 103.

In some embodiments the metadata generator 103 is also configured to receive the multichannel signals and analyse the signals to produce metadata 104 associated with the multichannel signals and thus associated with the transport signals 106. The analysis processor 103 may be configured to generate the metadata which may comprise, for each time-frequency analysis interval, a direction parameter and an energy ratio parameter and a coherence parameter (and in some embodiments a diffuseness parameter). The direction, energy ratio and coherence parameters may in some embodiments be considered to be MASA spatial audio parameters (or MASA metadata). In other words, the spatial audio parameters comprise parameters which aim to characterize the sound-field created/captured by the multichannel signals (or two or more audio signals in general).

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons. The transport signals 106 and the metadata 104 may be passed to a combined encoder core 109.

In some embodiments the transport signal generator 105 is configured to receive the multichannel signals and generate a suitable transport signal comprising a determined number of channels and output the transport signals 106 (MASA transport audio signals). For example, the transport signal generator 105 may be configured to generate a 2-audio channel downmix of the multichannel signals. The determined number of channels may be any suitable number of channels. The transport signal generator in some embodiments is configured to otherwise select or combine, for example, by beamforming techniques the input audio signals to the determined number of channels and output these as transport signals.

In some embodiments the transport signal generator 105 is optional and the multichannel signals are passed unprocessed to a combined encoder core 109 in the same manner as the transport signal are in this example.

The audio objects 104 may be passed to the audio object analyser 107 for processing. In some embodiments the audio object analyser 107 analyses the object audio input stream 104 in order to produce suitable audio object transport signals and audio object metadata. For example, the audio object analyser may be configured to produce the audio object transport signals by downmixing the audio signals of the audio objects into a stereo channel together using amplitude panning based on the associated audio object directions. Additionally, the audio object analyser may also be configured to produce the audio object metadata associated with the audio object input stream 104. The audio object metadata may comprise direction values which are applicable for all sub-bands. So, if there are 4 objects, there are 4 directions. In the examples described herein the direction values also apply across all of the subframes of the frame, but in some embodiments the temporal resolution of the direction values can differ and the directions values apply for one or more than one sub-frames of the frame. Furthermore, energy ratios (or ISM ratios) may be determined for each object. The energy ratio (ISM ratio) defines the contribution of the object within the object part of the total audio environment. In the following examples the energy ratios (or ISM ratios), are for each time-frequency tile for each object.

Obtaining the ISM ratios has been presented, e.g., WO2022/200666. As an example, they can be obtained as follows.

First, the object audio signals S_{obj}(t, i) are transformed to time-frequency domain S_{obj}(b, n, i) (where t is the temporal sample index, b the frequency bin index, n the temporal frame (or subframe or slot) index, and i the object index. The time-frequency domain signals can, e.g., be obtained via short-time Fourier transform (STFT) or complex-modulated quadrature filterbanks (QMF) (or low-delay variants of them).

Then, the energies of the objects are computed in frequency bands

$${E}_{obj} ( k , n , i ) = {\sum }_{{b}_{k , l o w}}^{{b}_{k , h i g h}} {\vert {S}_{obj} ( b , n , i ) \vert}^{2}$$

where b_{k,low} is the lowest and b_{k,high} the highest bin of the frequency band k. Then, the ISM ratios ξ(k,n, i) can be computed as

$$ξ ( k , n , i ) = \frac{{E}_{obj} ( k , n , i )}{{\sum }_{o = 0}^{O - 1} {E}_{obj} ( k , n , i )}$$

where O is the number of objects.

In some embodiments, the temporal resolution of the ISM ratios may be different than the temporal resolution of the time-frequency domain audio signals S_{obj}(b, n, i) (i.e., the temporal resolution of the spatial metadata may be different than the temporal resolution of the time-frequency transform). In those cases, the computation (of the energy and/or the ISM ratios) may include summing over multiple temporal frames of the time-frequency domain audio signals and/or the energy values.

The ISM ratios are numbers between 0 and 1 and they correspond to the fraction with which one object is active within the audio scene created all the objects. For each object there is one ISM ratio per frequency subband and time subframe. By definition, for each subband and subframe, the sum of ratios across objects is 1.

In some embodiments, the audio object analyser 107 may be sited elsewhere and the audio objects 104 input to the analyser and encoder 101 is audio object transport signals and audio object metadata.

The analyser and encoder 101 may comprise a combined encoder core 109 which is configured to receive the transport audio (for example downmix) signals 106 and audio object transport signals 128 in order to generate a suitable encoding of these audio signals.

The analyser and encoder 101 may also comprise an audio object metadata encoder 111 which is similarly configured to receive the audio object metadata 108 and output an encoded or compressed form of the input information as encoded audio object metadata 112.

In some embodiments the combined encoder core 109 can be configured to implement a stream separation metadata determiner and encoder which can be configured to determine the relative contributory proportions of the multichannel signals 102 (which can be also known as MASA audio signals) and audio objects 104 to the overall audio scene. The following examples describe the combination of the multichannel audio signals and audio objects but in some embodiments the multichannel audio signals can be generalised as spatial audio signals. This measure of proportionality produced by the stream separation metadata determiner and encoder may be used to determine the proportion of quantizing and encoding “effort” expended for the input multichannel signals 102 and the audio objects 104.

In other words, the stream separation metadata determiner and encoder may produce a metric which quantifies the proportion of the encoding effort expended on the multichannel audio signals 102 compared to the encoding effort expended on the audio objects 104. This metric may be used to drive the encoding of the audio object metadata 108 and the metadata 104. Furthermore, the metric as determined by the separation metadata determiner and encoder may also be used as an influencing factor in the process of encoding the transport audio signals 106 and audio object transport audio signal 128 performed by the combined encoder core 109. The output metric from the stream separation metadata determiner and encoder can furthermore be represented as encoded stream separation metadata and be combined into the encoded metadata stream from the combined encoder core 109.

In some embodiments the analyser and encoder 101 comprises a bitstream generator 113 configured to obtain the encoded metadata 116, the encoded transport audio signals 138 and the encoded audio object metadata 112 and generate the bitstream 118 for potential transmission or storage.

In some embodiments the analyser and encoder 101 comprises an encoder controller 115. The encoder controller 115 can in some embodiments control the encoding implemented by the audio object metadata encoder 111 and the combined encoder core 109. In some embodiments encoder controller 115 is configured to determine the bitrate for the bitstream 118 and based on the bitrate control the encoding. In some embodiments the encoder controller 115 is further configured to control at least one of the audio object analyser 107, transport signal generator 105 and metadata generator in generating parameters.

The analyser and encoder 101 can in some embodiments be a computer or mobile device (running suitable software stored on memory and on at least one processor), or alternatively a specific device utilizing, for example, FPGAs or ASICs. The encoding may be implemented using any suitable scheme. In some embodiments the encoder 107 may further interleave, multiplex to a single data stream or embed the encoded MASA metadata, audio object metadata and stream separation metadata within the encoded (downmixed) transport audio signals before transmission or storage shown in FIG. 1 by the dashed line. The multiplexing may be implemented using any suitable scheme.

Furthermore with respect to FIG. 1 is shown an associated decoder and renderer 109 which is configured to obtain the bitstream 118 comprising encoded metadata 116, Encoded transport audio signals 138 and encoded audio object metadata 112 and from these generate suitable spatial audio output signals. The decoding and processing of such audio signals are known in principle and are not discussed in detail hereafter other than the decoding of the encoded ISM ratio metadata.

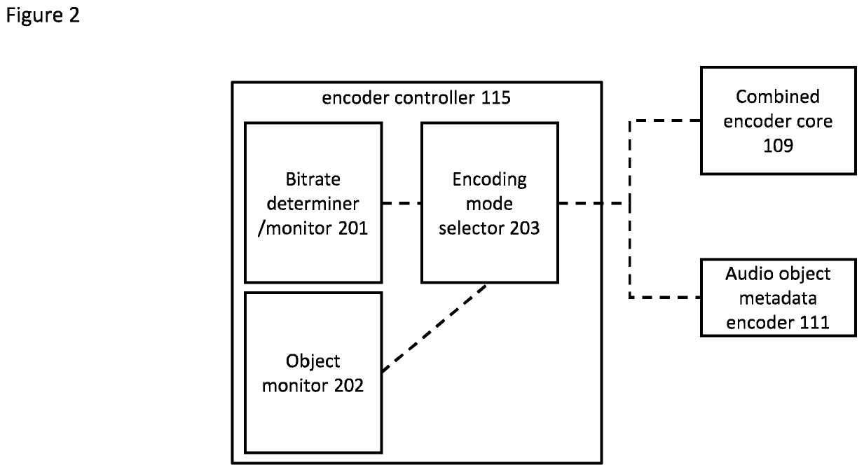

With respect to FIG. 2 is shown in further detail the encoder controller 115 according to some embodiments.

In this example the encoder controller 115 comprises a bitrate determiner/monitor 201 configured to determine and/or monitor the available bitrate for the bandwidth for the encoded audio and metadata. This could be determined based on a transmission path bandwidth estimation (and for example be based on an estimated signal strength) or a bandwidth storage determination to maintain the file for a determined time to be below a required size or by any suitable manner.

Additionally in some embodiments the encoder controller 115 comprises an object monitor 202 configured to determine the number of objects and pass this information to the encoding mode selector 203.

The bitrate determiner/monitor 201 and object monitor 202 can furthermore be configured to control an encoding mode selector 203.

The encoder controller 115 can comprise an encoding mode selector 203 configured to select an encoding mode, for example based on the determined bandwidth or bitrate and then control the encoders, for example the combined encoder core 109 and audio object metadata encoder 111.

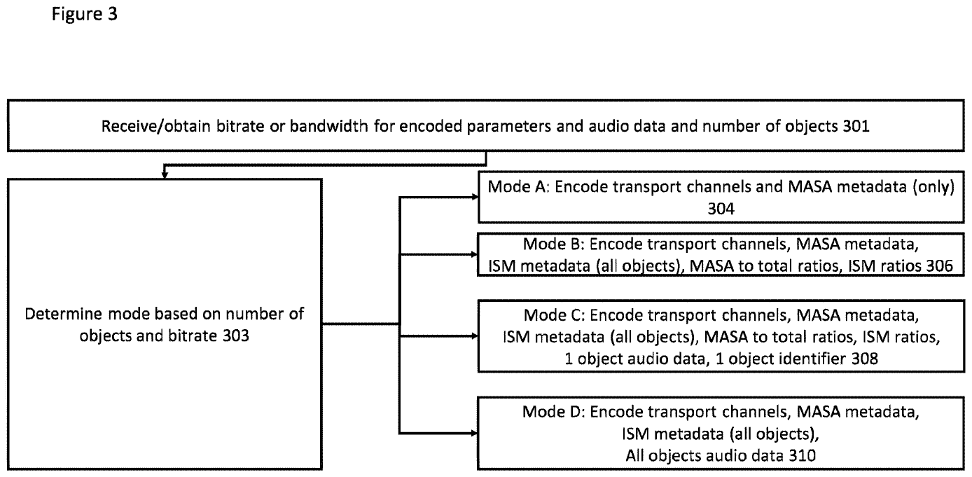

With respect to FIG. 3 is shown a flow diagram of an example operation of the encoder controller shown in FIG. 2 In this example there is an initial operation of receiving or obtaining or otherwise determining the bitrate or bandwidth for encoded parameters and audio data and furthermore the number of objects as shown in FIG. 3 by step 301.

Having obtained the available bandwidth or bitrate and number of objects then a determination as to one of a number of encoding modes can be implemented based on the bandwidth/bitrate and number of objects as shown in FIG. 3 by step 303.

In some embodiments the mode selection can be made based on the following table

| Total | Encoding Mode | | | | | | | |
|---|---|---|---|---|---|---|---|---|
| bitrate | (Bitrate per separated object (kbps)) | | | | | | | |
| (kbps) | 1obj | | 2obj | | 3obj | | 4obj | |
| 13.2 | A | (0) | A | (0) | A | (0) | A | (0) |
| 16.4 | A | (0) | A | (0) | A | (0) | A | (0) |
| 24.4 | D | (9.6) | A | (0) | A | (0) | A | (0) |
| 32 | D | (11) | C | (0) | A | (0) | A | (0) |
| 48 | D | (13.2) | D | (9.6) | B | (0) | B | (0) |
| 64 | D | (16) | D | (11.7) | C | (0) | C | (0) |
| 80 | D | (20) | D | (16) | C | (0) | C | (0) |
| 96 | D | (32) | D | (20) | D | (16) | C | (0) |
| 128 | D | (32) | D | (24.4) | D | (20) | D | (16) |
| 160 | D | (48) | D | (32) | D | (24.4) | D | (20) |
| 192 | D | (64) | D | (48) | D | (32) | D | (24.4) |
| 256 | D | (96) | D | (64) | D | (48) | D | (32) |
| 384 | D | (128) | D | (80) | D | (64) | D | (48) |
| 512 | D | (128) | D | (96) | D | (80) | D | (64) |

Mode A is one where the encoders can be controlled to encode the transport channels and MASA metadata only as shown in FIG. 3 by step 304.

Mode B is one where the encoders can be controlled to encode transport channels, MASA metadata, ISM metadata (all objects), MASA to total ratios, ISM ratios as shown in FIG. 3 by step 306.

Mode C is one where the encoders can be controlled to encode transport channels, MASA metadata, ISM metadata (all objects), MASA to total ratios, ISM ratios, and 1 object audio data, with 1 object identifier as shown in FIG. 3 by step 308.

Mode D is one where the encoders can be controlled to encode transport channels, MASA metadata, ISM metadata (all objects) as shown in FIG. 3 by step 310.

The bitrates/object number based mode selection shown herein are examples and it would be understood that they can be other specific values.

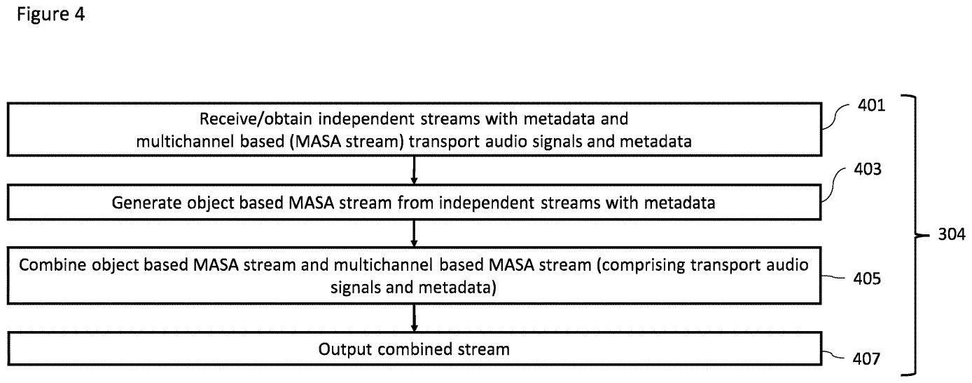

For example FIG. 4 shows the mode A encoding method, the first (or lowest or combined) encoding mode as shown in FIG. 3 by step 304 in further detail. Thus for the lowest total bitrates all encoding is implemented using a MASA representation Thus for example there is an operation of receiving/obtaining the object based streams (independent streams with metadata) and multichannel based (MASA stream) transport audio signals and metadata as shown in FIG. 4 by step 401.

Then, as shown in FIG. 4 by step 403, there is an operation of generating an object based MASA stream from the object streams (independent streams with metadata). This object based MASA stream can in some embodiments be created from the object stream using, for example, the methods presented in WO2019086757A1.

After this, as shown in FIG. 4 by step 405, the object based MASA stream and multichannel based MASA stream are combined. In some embodiments the original MASA stream and the MASA stream created from the objects can be combined using the method presented in GB2574238. The decoder gets the objects and the MASA audio content in the MASA format.

Then the combined stream is output as shown in FIG. 4 by step 407. In such embodiments the object audio content (together with the MASA audio content) is present in the decoded audio scene, but the objects cannot be edited nor separated from the scene at the decoder.

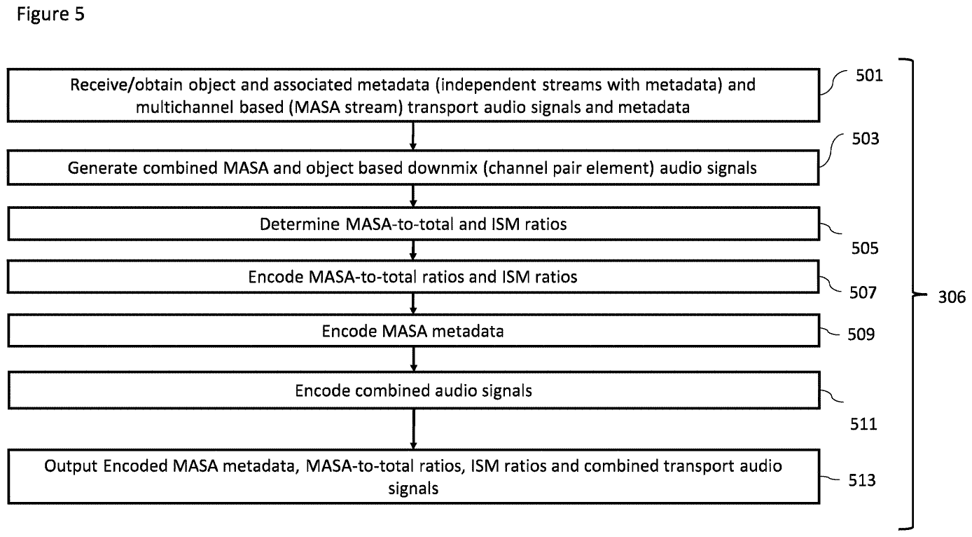

FIG. 5 shows the mode B encoding method, the second (or lower or object metadata) encoding mode as shown in FIG. 3 by step 306. Since (for the same number of objects) there are a more bits available compared to the mode A encoding method, there is a possibility to parameterize the audio scene, by sending one common audio data downmix, the MASA metadata, the ISM metadata, and additional parameter sets indicating for each time frequency tile how much of the signal corresponds to the MASA component out of the total audio scene (in other words this can be presented or indicated by the MASA-to-total energy ratios) and ratios indicating how the audio scene corresponding to the objects is distributed between the ISMs (in other words this can be presented or indicated by the ISM ratios).

Thus for example there is a method step of receiving/obtaining the object based streams (independent streams with metadata) and multichannel based (MASA stream) transport audio signals and metadata as shown in FIG. 5 by step 501.

Then, as shown by step 503 in FIG. 5, generate a combined MASA and object based downmix (channel pair element) audio signals. In other words, the audio content of MASA and the objects is downmixed to 2 channels (channel pair element CPE).

The MASA-to-total ratios and the ISM ratios can be determined as shown in FIG. 5 by step 505.

The MASA-to-total ratios and the ISM ratios can then be encoded based on any suitable encoding method. For example the ISM ratios can be encoded using a lattice encoding method or the MASA-to-total ratios encoded by DCT transforming followed by entropy coding (for example such as described in WO2022/200666). The encoding of the MASA-to-total ratios and the ISM ratios is shown in FIG. 5 by step 507.

Furthermore the MASA metadata can then be encoded based on any suitable MASA metadata encoding method as shown in FIG. 5 by step 509.

The combined audio signals can then be encoded based on any suitable audio signal encoding method as shown in FIG. 5 by step 511.

The encoder can then output Encoded MASA metadata, MASA-to-total ratios, ISM ratios and combined transport audio signals as shown in FIG. 5 by step 513.

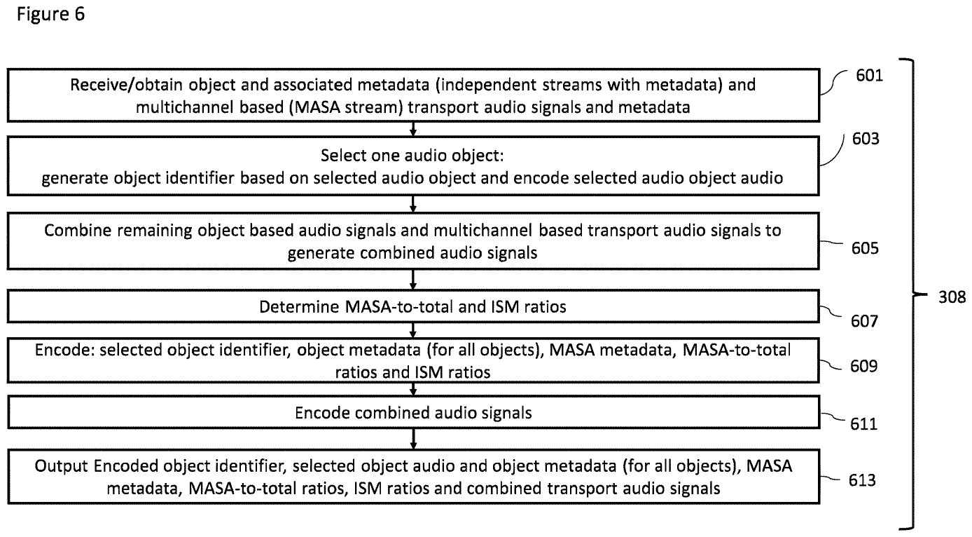

FIG. 6 shows the mode C encoding method, the third (or higher or one object) encoding mode as shown in FIG. 3 by step 308. Thus (for the same number of objects) for higher bitrates than mode A or B encoding method bitrates, the audio content of (only) one object is separated and sent independently. In addition, the downmix formed from the MASA transport channels and the rest of the objects are sent under MASA format with the additional parameters of the MASA-to-total energy ratios and ISM ratios. Moreover, the ISM metadata is sent, and an identifier describing which object was separated. At each frame it is decided which object is to be separated. The decision may, e.g., be based on the relative level of the objects with respect to other objects (e.g., separate the loudest object).

This is explained in detail in WO2022/214730.

Thus for example there is a method step of receiving/obtaining the object based streams (independent streams with metadata) and multichannel based (MASA stream) transport audio signals and metadata as shown in FIG. 6 by step 601.

Then, as shown by step 603 in FIG. 6, one audio object is selected and an object identifier generated based on selected audio object. Furthermore the audio signal associated with the selected audio object is encoded. Any suitable audio signal encoder may be used for encoding the audio signal of the selected object. For example, the same or similar audio signal encoder as used for encoding the MASA audio signal(s) can be employed.

Then a combined MASA and remaining (or non-selected) object based transport audio signals (or downmix) is generated as shown by FIG. 6 by step 605. The object transport signals can be created in the same manner as presented in the previous mode, mode B, with the difference being that the selected or separated object not included within the mix. For example the multichannel or MASA audio signals and the (non-selected) object transport signals can be summed together to generate the combined transport audio signals. It should be noted that the objects are not separated from the mix or (re)inserted into the mix abruptly, but through a suitable fade-in/fade-out mode by setting non-zero values to the corresponding ISM ratio in the mix. As such this requires all objects ISM ratios to be encoded even if one object is separated from of the mix.

There is one exception where for a given sub-band, in the first subframe the ratio for the separated object is zero. This means that in the same frame, all subsequent subframes will have the same value of the ISM ratio of the separated object and there is no need to encode and send it.

The MASA-to-total ratios and the ISM ratios can be determined as shown in FIG. 6 by step 607.

The object identifier, MASA metadata, MASA-to-total ratios and the ISM ratios can then be encoded based on any suitable lattice encoding or entropy encoding method as shown in FIG. 6 by step 609. The encoding of the MASA-to-total energy ratio encoding can be implemented in the manner as described in WO2022/200666. The encoding of the ISM ratios is described later in further detail.

The combined audio signals can then be encoded based on any suitable MASA audio signal encoding method as shown in FIG. 6 by step 611. The encoding is of the combined transport audio signals can employ any suitable transport audio signal encoding, for example the audio signal(s) encoder of the IVAS encoder.

In other words the separated object is determined, separated and encoded as described in WO2022/214730, and for the remaining objects and the MASA stream the processing works as was described in WO2022/200666.

The encoder can then output the encoded object identifier, MASA metadata, MASA-to-total ratios, ISM ratios, object metadata (for all objects), selected single object audio signal and combined transport audio signals as shown in FIG. 6 by step 613.

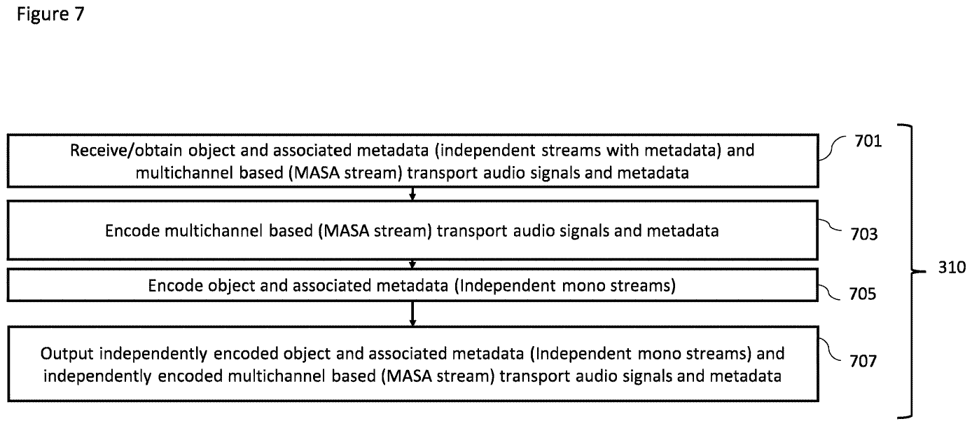

FIG. 7 shows the mode D encoding method, the fourth (or highest or all objects) encoding mode as shown in FIG. 3 by step 310. Thus in the higher bitrates (for a specific number of objects and compared to the mode A, B or C encoding method bitrates) the two input audio formats, MASA and ISM are independently encoded and transmitted in the same bitstream (in other word using a single instance of the IVAS codec).

Thus for example there is a method step of receiving/obtaining the object based streams (independent streams with metadata) and multichannel based (MASA stream) transport audio signals and metadata as shown in FIG. 7 by step 701.

Then, as shown by step 703 in FIG. 7, there is encoded the multichannel based (MASA stream) transport audio signals and metadata based on any suitable MASA encoding method.

The object (independent streams with metadata) and associated metadata can furthermore be encoded as shown in FIG. 7 by step 705. Any suitable mono encoder can be employed to implement the encoding, for example an EVS based mono encoder block.

The encoder can then output the independently encoded object (independent streams with metadata) and associated metadata and independently encoded multichannel based (MASA stream) transport audio signals and metadata as shown in FIG. 7 by step 707.

With respect to the following the generation and encoding of the ISM ratio values, such as determined and encoded within the encoding modes B and C, is described in further detail.

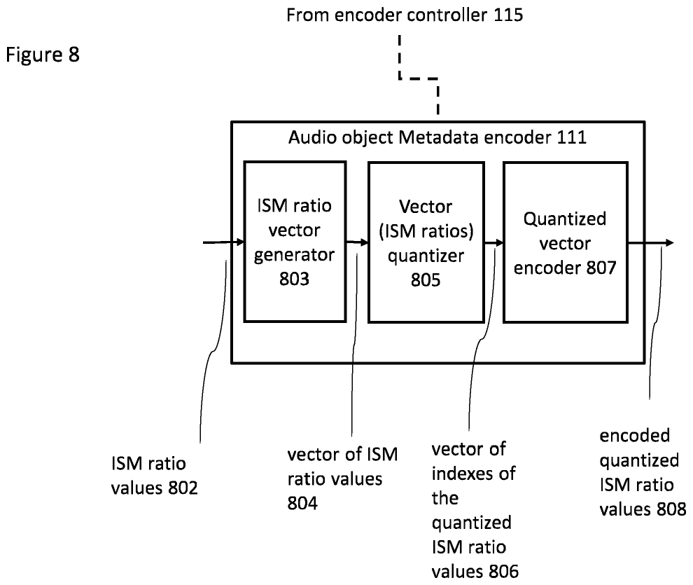

Thus with respect to FIG. 8 is shown in further detail an audio object metadata encoder 111 according to some embodiments. Although in some embodiments the MASA-to-total ratios and the directions (i.e., the azimuth and elevation angle per object) are forwarded and encoded by the audio object metadata encoder 111, the specific encoding of the directions and MASA-to-total ratio is not described herein in any further detail. For example, WO2022/200666 describes a suitable MASA-to-total ratio encoding method and PCT/EP2017/078948 and U.S. Ser. No. 11/475,904 describes a suitable direction value encoding method.

As discussed above the ISM ratios are passed to the audio object metadata encoder 111.

In some embodiments, the audio object metadata encoder 111 comprises an ISM ratio vector generator 803 which is configured to receive the ISM ratio values and generate a vector representation of the ISM ratios for the sub-band and the subframe. In other words the vector describes the ISM values for all objects of a given time-frequency tile. The vector of ISM ratio values 804 can then be passed to the vector (ISM ratios) quantizer 805. The vector can also be known as an arrangement or grouping of the ISM ratio values.

In some embodiments the audio object metadata encoder 111 comprises a vector (ISM ratios) quantizer 805 configured to receive the vectors of ISM ratios 804 and quantize them.

In some embodiments for each sub-band and time subframe the ratios can be scalarly quantized on nb=3 bits. As such the quantization of each of the ratios returns a positive integer value in binary from 000 to 111 (or 0 to 7 in decimal or base 10 form). In other embodiments the quantization can be performed using any suitable number of bits. Thus although the following examples show a uniform scalar quantizer based on 3 bits for each value. It can also be a non-uniform scalar quantizer. The distribution of the indexes does not influence the indexing. However, this could in principle be taken into account by observing that some vector indexes are more probable than others. Quantizers based on more than 3 bits can be employed in some embodiments.

By definition, for each subband and subframe, the sum across objects is 1. For each subband and time subframe the values are scalarly quantized on nb=3 bits. Because the ISM ratios sum up to 1, there is a corresponding relationship between the quantization indexes and they should sum up to 2\hat{ }nb−1 (=7). This enables reducing the number of indexes that are sent. They can be sent for one object less for each subband. However, due to the non-linearity of the quantization operation, the reconstruction at the decoder may not be optimal respecting the condition of summing up to a constant in the index domain. As such in some embodiments the quantization operation can further comprise a quantization optimization operation and features a quantization of a constrained vector.

Thus in some embodiments the quantization of the indexes for each subband and each subframe can be implemented based on the following operations:
1. For o=0:0-1
   a. Quantize to the lowest nearest neighbour the ISM ratios rISM(o) and obtain the index idx(o) (i.e., from the two adjacent possible quantized values, select the one that has the lower value).
2. End
3. Calculate the reconstructed values of the ISM ratios using the formula

$${\sum }_{o = 0}^{O - 1} idx ( o ) \cdot σ ,$$

where σ is the quantization step.
4. Calculate the Euclidean distortion between the reconstructed ratios and the unquantized ones
5. Calculate sum of quantized indexes, SI
6. While SI<K
   a. Check which quantized index to increase by 1 unit for a possible decrease of the resulting Euclidean distortion in the ISM ratio domain
   b. Select best component
      i. The one that decreases the most the Euclidean distortion or, if there cannot be any decrease, the one that increases it by the least amount.
   c. Update the selected index, by adding one unit
   d. Update sum of quantized indexes (SI=SI+1)
7. End While
8. Encode the quantized indexes.

It is to be noted that the modifications of the indexes are performed only by increasing their values, because the quantization operation is forced to always take the lowest neighbour in the scalar quantization.

In some embodiments for the encoding of one separated object mode the ISM ratio of the separated mode is zero then its corresponding quantized value stays at zero and cannot be changed in the above. The changes made to obey the sum constraint are thus implemented only for the other objects ISM ratio indexes.

This quantization process ensures that the sum of indexes across the objects equals K.

The vector of indexes of the quantized ISM ratio values 806 can then be passed to a quantized vector encoder 807.

The audio object metadata encoder 111 can in some embodiments comprise a quantized vector encoder 807. The quantized vector encoder 807 can be configured to obtain the vector of indexes of the quantized ISM ratio values 806 and from these generate suitable encoded quantized ISM ratio values 808 which can for example be passed to a bitstream generator 113 to be included within the bitstream 118.

In some embodiments there are two modes of differential coding that are tested: index difference with respect to previous subframe data and index difference with respect to previous subband data.

In some embodiments differential encoding with respect to the previous subframe is applied only for subframes starting with the second subframe.

There are B×N 0-dimensional integer vectors of ISM ratio indexes. The encoding of the ISM ratio indexes is presented in the following:
1. First subframe ISM ratio quantized data is encoded with the enumeration index
   a. For each subband of the first subframe
      i. Encode the vector of O integer values that sum up to the value 2\hat{ }nb−1 (=7), as an enumeration index.
   b. End for
2. For each subframe 1 to N−1
   a. For each subband from 0 to B−1
      i. Calculate for each object the difference index with respect to previous subframe
      ii. Transform the difference index to positive index
      iii. The positive indexes are encoded with GR code with parameter 0 and corresponding number of bits are estimated
      iv. The positive indexes are encoded with GR code with parameter 1 and corresponding number of bits are estimated
      v. Calculate for each object the difference index with respect to previous subband (if there is no previous subband, use data from previous subframe)
      vi. Transform the difference index to positive index
      vii. The positive indexes are encoded with GR code with parameter 0 and corresponding number of bits are estimated
      viii. The positive indexes are encoded with GR code with parameter 1 and corresponding number of bits are estimated
   b. End For
   c. For each differential coding mode (wrt. subband/wrt. subframe)
      i. Select the optimal GR parameter for using the mode over all subband data in current subframe
   d. End for
   e. Select the differential coding mode (difference to previous subframe or previous subband) for the current subframe as the one giving the shortest codelength for the subframe
3. End for

The tested GR parameter values are 0 and 1.

The differential coding with GR parameter G, for subframe i and subband b with respect to the “previous” vector is presented below:
1. Calculate for each object the difference index with respect to a “previous” vector
2. Transform the difference index to a positive index
3. The positive indexes are encoded with a GR code with parameter G and a corresponding number of bits are estimated

The encoding of the ISM ratios for the one separated object mode is presented next. For the first subframe:
1. ISM ratios for all valid subbands are encoded with the enumeration index and the total number of bits over the subbands is counted
2. The first subband is encoded with an enumeration index and subsequent subbands are differentially encoded with respect to previous subband, using GR parameter of value 0. The corresponding number of bits are estimated.
3. One of the two above methods is selected based on which one uses less bits.
4. One bit is used to indicate the coding method for first subframe

A valid subband of the subframe is one for which the MASA to total energy ratio value is less than 1 (or less than a threshold close to 1, e.g. 0.98).

After the encoding of the first subframe ISM ratios data the values of the ISM ratios of the separated object for each subband of the first subframe are checked. If they are all zero, the ISM ratios of the separated object of the following subframes, for all subbands will not be sent, as they are supposed to be zero as well.

In other words we check:
1. If (num_objects>2) && (ratio index corresponding to separated object==0 for all subbands of first subframe)
   1.1. D=2
2. Else
   2.1. D=1
3. End if
   O-D ISM ratios will be sent for each subsequent subband, where O is the number of objects and D is determined above.

If there are only 2 objects and the ratio indexes of the separated object for all subbands of the first subframe are zero, nothing else is sent for the encoding of the ISM ratios of the current frame. In other words, O=2 and O-D=0.

The bitstream for one frame in such embodiments contains the following ISM ratios related data:
Vector index for the first subframes of all subbands
For each subframe, with the exception of the first one
   1 bit indicating the differential coding mode (with respect to previous subframe or previous subband)
   1 bit indicating the GR order (0 or 1)
   GR encoded differential indexes

For the first subband, the difference can be taken with respect to the previous subframe data, because there is no subband data to look back to. The GR parameter and differential coding flags can be decided for each subframe, and they are valid for all subbands corresponding to that subframe.

In some embodiments there can also be a differential mode with respect to the previous subband with respect to the first subframe. In other words replace 1 from the above with the following
1. First subframe ISM ratio quantized data is encoded with the enumeration index
   a. For first subband of the first subframe
      i. Encode the vector of O integer values that sum up to the value 2\hat{ }nb−1 (=7), as an enumeration index.
   b. For each subband (of the first subframe) 1 to B−1
      i. Calculate for each object the difference index with respect to previous subband
      ii. Transform the difference index to positive index
      iii. The positive indexes are encoded with GR code with parameter 0 and corresponding number of bits are estimated
   c. End For

In some embodiments the selection can be implemented to be valid across subframes and decided for each subband, or to be decided for each subframe and subband individually.

The encoding using the enumeration index is made as presented in GB2217884.2.

When processing the data, there is special case where all ISM ratios are 0 and they do not obey the constant sum constraint. This case corresponds to no audio signal in the objects or no audio signal at all. The information that there is no audio signal in the objects, can be inferred from the MASA-to-total energy ratios. If the MASA-to-total energy ratio for a TF tile (identified by subband and subframe) is 1, then there is no need to send the ISM ratios for that TF tile.

When there is no audio signal at all, the MASA-to-total energy ratios can be forced to 1, allowing thus to infer the degenerate all zero values case of ISM ratios from the MASA-to-total energy ratio values.

In some embodiments, for the mode C encoding (separated object mode) case, as the separated object makes a contribution in the remaining mix enables the encoding to be more stable in time (there is still something left of it in the mix after separation). Additionally this can, in some embodiments, be exploited when considering the differential coding.

In order to do so, before encoding the ratios of the first 0-1 objects in each subband and each subframe the ratio indexes corresponding to the separated object are determined to be within the indexes which are going to be stored or transmitted.

For instance if, for the 4 objects case, at a particular subband on a subframe that is not the first one, then the ISM ratio index values are [3 0 2 2] and the separated object is the second one (having the ISM ratio index 0) then nothing is changed and the encoding procedure is implemented on the first 3 indexes [3 0 2].

However in an example where the separated object is the last object and the ISM ratio indexes are [3 1 3 0] the method is configured to switch places between the 3^{rd} and 4^{th} objects ISM ratios, obtaining the array [3 1 0 3] and then encode the array [3 1 0].

By implementing this switch, because of the separated object the ISM ratio corresponding to it would vary very little across subframes or subbands, then the resulting differential encoding would result in an average smaller codelength.

In some embodiments it can be possible to reduce the number of ratios which are sent. This can be implemented, for example, if the ISM ratios for the separated object for all subbands in the first subframe are zero. Then the ISM ratio for the subsequent subframes for the separated object are zero as well and they are not sent.

The C code corresponding to the switch and encoding operation is:

```
#ifdef ONE_SEP_OBJ_UPDATE
  rotate = 0;
#endif
  for ( sf = 0; sf < numSf; sf++ )
  {
    for ( band = 0; band < numCodingBands; band++ )
    {
      for ( obj = 0; obj < hMasa->data.nchan_ism; obj++ )
      {
        assert( ( hMasa->data.energy_ratio_ism[sf][band][obj] >= 0 ) && ( hMasa-
>data.energy_ratio_ism[sf][band][obj] <= 1 ) );
        ratio_ism[band][obj] = hMasa->data.energy_ratio_ism[sf][band][obj];
        }
        /* Quantize power ratios */
        quantize_ratio_ism_vector( ratio_ism[band], ratio_ism_idx[band], hMasa-
    >data.nchan_ism, hQMetaData->masa_to_total_energy_ratio[sf][band] );
        /* reconstructed values */
        reconstruct_ism_ratios( ratio_ism_idx[band], hMasa->data.nchan_ism,
    step, hMasa->data.q_energy_ratio_ism[sf][band] );
        /* encode vector */
  }
#ifdef ONE_SEP_OBJ_UPDATE
  if ( ( hMasa->data.nchan_ism > 2) && ( idx_separated_object == hMasa-
>data.nchan_ism − 1 ) )
  {
    /* rotate components */
    rotate = 1;
    for ( band = 0; band < numCodingBands; band++ )
    {
      tmp = ratio_ism_idx[band][hMasa->data.nchan_ism − 1];
      ratio_ism_idx[band][hMasa->data.nchan_ism − 1] = ratio_ism_idx[band][0];
      ratio_ism_idx[band][0] = tmp;
    }
  }
#endif
  /* encode data for current subframe */
  encode_ratio_ism_subframe( ratio_ism_idx, hMasa->data.nchan_ism,
numCodingBands, sf, ratio_ism_idx_prev_sf, hMetaData, hQMetaData-
>masa_to_total_energy_ratio[sf] );
  /* calculate quantized ISM ratios */
  /* save previous subframe indexes */
  for ( band = 0; band < numCodingBands; band++ )
  {
    mvs2s( ratio_ism_idx[band], ratio_ism_idx_prev_sf[band], hMasa-
  >data.nchan_ism );
  }
#ifdef ONE_SEP_OBJ_UPDATE
  if ( rotate )
  {
    for ( band = 0; band < numCodingBands; band++ )
    {
      tmp = ratio_ism_idx[band][hMasa->data.nchan_ism − 1];
      ratio_ism_idx[band][hMasa->data.nchan_ism − 1] = ratio_ism_idx[band][0];
      ratio_ism_idx[band][0] = tmp;
    }
  }
#endif
  }
```

At the decoder after receiving and decoding O−1 ISM ratio indexes, the switch between the separated object and the first object will be performed if the separated object is the last in the list.

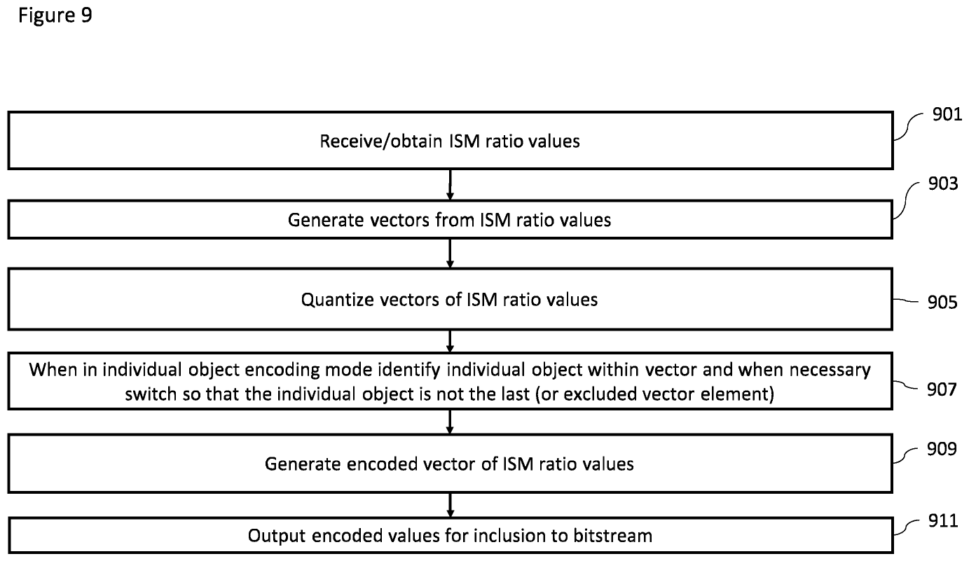

With respect to FIG. 9 is shown a flow diagram which summarises the operations of the example audio object metadata encoder 111 shown in FIG. 8.

The initial operation is one of receiving/obtaining the ISM ratio values as shown in FIG. 9 by step 901.

From the ISM ratios the next operation is generating vectors from ISM ratio values as shown in FIG. 9 by step 903.

Having determined the vector of ISM ratio values, they can be quantized to generate quantized vectors of ISM ratio values as shown in FIG. 9 by step 905.

When the encoder is in an individual object encoding mode (encoding mode C) then identify the individual object within the vector and when necessary switch so that the individual object is not the last (or excluded vector element) as shown in FIG. 9 by step 907.

Then from the quantized vectors are generated index values representing the encoded quantized vectors as shown in FIG. 9 by step 909.

The encoded ISM vector index values can then be output for inclusion to the bitstream as shown in FIG. 9 by step 911.

The decoder can be configured to decode the ISM values using the opposite processes to those described above. As such a decoder can be configured to obtain the ISM ratio vales from the encoded vector values based on the following operations:

| 1. | For sf = 1:num_subframes | |
|---|---|---|
| | 1.1. | Decode/Read ISM ratio index vectors for all subbands |
| | 1.2. | Save current subframe data to previous subframe data |
| | 1.3. | Reconstruct ISM ratios from the ISM ratio indexes |

| | |
|---|---|
| 2. | End for |

Decoding the ISM ratio indexes for the subframe sf:

| 1. | If first subframe | |
|---|---|---|
| | 1.1. | For b = 1:num_subbands |

| | |
|---|---|
| 1.1.1. | Read index for the ISM ratios index vector for subband b |
| 1.1.2. | Decode index (for example according to GB2217884.2) into |

| | |
|---|---|
| | vector of indexes |
| 1.2. | End for |
| 1.3 | If (num_objects > 2) && (ratio index corresponding to separated object |

== 0 for all subbands of first subframe)

| | |
|---|---|
| 1.3.1 | D = 2 |

| | |
|---|---|
| 1.4 | Else |

| | |
|---|---|
| 1.4.1 | D = 1 |

| | |
|---|---|
| 1.5 | End if |
| 1.3. | For b = 2:num_subbands |

| | |
|---|---|
| 1.3.1. | Read bit to determine if differential coding |
| 1.3.2 | If not differential coding |

| | |
|---|---|
| 1.3.2.1 | Read index for the ISM ratios index vector for subband |

b

| | |
|---|---|
| 1.3.2.2 | Decode index (for example according to GB2217884.2) |

```
    into vector of indexes
    1.3.3 Else
```

| | |
|---|---|
| 1.3.3.1 | For i = 1:num_objects-D |

| 1.3.3.1.1 | Read and decode GR code into positive index |
|---|---|
| (GR order 0) | |
| 1.3.3.1.2 | Transform positive index into integer |
| corresponding to difference index | |
| 1.3.3.1.3 | . Calculate ISM ratio index of subband b as sum |

| of previous subband ISM ratio index + the decoded | |
|---|---|
| difference | |
| 1.3.3.2 | End for |

| | |
|---|---|
| 1.3.4. | End else |

| | 1.4. | End for |
|---|---|---|
| 2. | Else | |
| | 2.1. | Read differential mode bit |
| | 2.2. | Read Golomb Rice order |
| | 2.3. | For b = 1:num_subbands |

| | |
|---|---|
| 2.3.1. | For i = 1:num_objects-D |

| | |
|---|---|
| 2.3.1.1. | Read and decode GR code into positive index |
| 2.3.1.2. | Transform positive index into integer corresponding to |

| | |
|---|---|
| | difference index |
| 2.3.2. | End for |

| | |
|---|---|
| 2.4. | End for |
| 2.5. | If differential mode with respect to previous subframe |

| | |
|---|---|
| 2.5.1. | For b = 1:num_subbands |

| | |
|---|---|
| 2.5.1.1. | For i = 1:num_objects-D |

| | |
|---|---|
| 2.5.1.1.1. | Calculate ISM ratio index of subband b as |

| | |
|---|---|
| | sum of previous subframe ISM ratio index + the |
| | decoded difference |
| 2.5.1.2. | End for |
| 2.5.1.3. | Calculate index corresponding to last object such that |

| the sum of indexes across objects is the constant K | |
|---|---|
| 2.5.2. | End for |

| | |
|---|---|
| 2.6. | Else |

| | |
|---|---|
| 2.6.1. | Calculate ISM ratio indexes for num_objects-1 of the first |

```
  subband as sum of previous subframe first subband ISM ratio index + the
  decoded difference
```

| | |
|---|---|
| 2.6.2. | For b = 2:num_subbands |

| | |
|---|---|
| 2.6.2.1. | For i = 1:num_objects-D |

| | |
|---|---|
| 2.6.2.1.1. | Calculate ISM ratio index of subband b as |

| sum of previous subband ISM ratio index + the decoded | |
|---|---|
| difference | |
| 2.6.2.2. | End for |
| 2.6.2.3. | Calculate index corresponding to last object such that |

| the sum of indexes across objects is the constant K | |
|---|---|
| 2.6.3. | End for |

| | |
|---|---|
| 2.7. | End if |
| 2.8. | (for separate object encoding mode) If separated object would be last |

in list perform switch between last and first indexes.

In the above example the decoder is shown implementing a decoding where the encoding method is configured not to encode an object where the ISM ratios for the separated object for all subbands in the first subframe are zero (as the ISM ratio for the subsequent subframes for the separated object are zero as well). In example decoders where this is not implemented the sections 1.1.3 to 1.1.5 can be replaced by
1.1.3 D=1

Or 1.1.3 to 1.1.5 deleted and all examples of D replaced by the value 1.

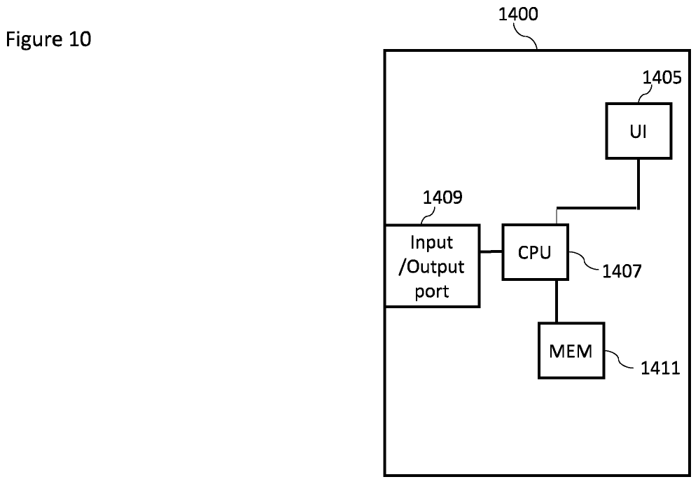

With respect to FIG. 10 an example electronic device which may be used as any of the apparatus parts of the system as described above. The device may be any suitable electronics device or apparatus. For example, in some embodiments the device 1400 is a mobile device, user equipment, tablet computer, computer, audio playback apparatus, etc. The device may for example be configured to implement the encoder/analyser part and/or the decoder part as shown in FIG. 1 or any functional block as described above.

In some embodiments the device 1400 comprises at least one processor or central processing unit 1407. The processor 1407 can be configured to execute various program codes such as the methods such as described herein.

In some embodiments the device 1400 comprises at least one memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating.

In some embodiments the device 1400 comprises an input/output port 1409.

The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (loT) RAN and Internet Protocol multimedia subsystems (IMS), any other suitable option and/or any combination thereof.

The transceiver input/output port 1409 may be configured to receive the signals.

In some embodiments the device 1400 may be employed as at least part of the synthesis device. The input/output port 1409 may be coupled to headphones (which may be a headtracked or a non-tracked headphones) or similar and loudspeakers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims.

However, all such and similar modifications of the teachings of this invention will still fall within the scope of this invention as defined in the appended claims.

1. An apparatus for encoding audio object parameters, the apparatus comprising at least one processor and at least one memory storing instructions that, when executed by the at least one processor, cause the apparatus at least to perform:
identifying one of at least two audio objects within an audio environment to be encoded separately;
obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element;
grouping, for the time-frequency elements, ratio parameters associated with the at least two audio objects,
quantizing the ratio parameters within the grouping, wherein the quantizing the ratio parameters is configured to generate integer representations of the ratio parameter values which sum for a specific grouping to a defined integer value;
encoding the integer representations of the ratio parameter values within a first grouping or first set of groupings as enumeration indexes;
encoding subsequent groupings as difference values with respect to the first grouping or first set of groupings, wherein the apparatus is caused to encode subsequent groupings by:
selecting a sub-set of the integer representations of the ratio parameter values for the subsequent groupings; and
encoding the selected sub-set of the integer representations of the ratio parameter value for the subsequent groupings as difference values with respect to the first grouping or first set of groupings,
wherein the apparatus is caused to group the ratio parameters by ordering the ratio parameters within the grouping such that the selected sub-set of the integer representations of the ratio parameter value comprises the integer representations of the ratio parameter value associated with the selected one of the at least two audio objects to be encoded separately.

2. The apparatus as claimed in claim 1, wherein the apparatus is caused to select a sub-set of the integer representations of the ratio parameter values for the subsequent groupings by selecting all but one of the integer representations for a specific grouping, as the integer representations of the ratio parameter values for the grouping is a defined value for every grouping.

3. The apparatus as claimed in claim 1, wherein the apparatus is caused to select a sub-set of the integer representations of the ratio parameter values for the subsequent groupings by:
determining that the integer representation of the ratio parameter value corresponding to the one of at least two audio objects within an audio environment to be encoded separately is zero for all frequency elements of the first time element; and
selecting all but two of the integer representations for a specific grouping, wherein the selecting does not include the integer representation of the ratio parameter value corresponding to the one of at least two audio objects within an audio environment to be encoded separately.

4. The apparatus as claimed in claim 1, wherein the apparatus is caused to group, for a time-frequency elements, ratio parameters associated with the at least one audio object by generating vectors of the ratio parameters.

5. The apparatus as claimed in claim 1, wherein the apparatus is caused to encode the integer representations of the ratio parameter values within a first grouping or first set of groupings as enumeration indexes by generating integer values based on an indexing from the grouping, wherein the generated integer value represents the ratio parameters for the audio objects.

6. The apparatus as claimed in claim 5, wherein the apparatus is caused to generate integer representations of the ratio parameter values which sum for a specific grouping to a defined integer value by:
generating a single number value by appending elements from the grouping of ratio parameters; and
generating the integer representation from the single number, by performing an iteration loop from a zeroth iteration up to and including the single number of iterations and sequentially associating index values to iteration loop iteration numbers which have a valid selection of ratio parameters, wherein the integer value is the highest index value.

7. The apparatus as claimed in claim 1, wherein the apparatus is caused to quantize the ratio parameters within the grouping by:
quantizing, using a lowest nearest neighbour scalar quantization, ratio values within a specific selection to obtain quantization index values;
calculating reconstructed values of the ratio parameters for the specific selection;
calculating an error value based on the difference between the reconstructed ratio values and the specific selection of ratio parameter values;
determining a sum of quantized index values; and
selecting at least one quantized index value to increment such that the sum of quantized index values is equal to an expected index sum.

8. The apparatus as claimed in claim 7, wherein the apparatus is caused to select at least one quantized index value to increment such that the sum of quantized index values is equal to an expected index sum by one of:
selecting the at least one quantized index value to increment based on identifying a greatest decrease within the error value when the index value is incremented; or
selecting the at least one quantized index value to increment based on identifying a minimum increase within the error value when the index value is incremented.

9. The apparatus as claimed in claim 1, wherein the apparatus is caused to encode the selected sub-set of the integer representations of the ratio parameter value for the subsequent groupings as difference values with respect to the first grouping or first set of groupings by:
performing with respect to selected sub-set of the integer representations of the ratio parameter value for the subsequent groupings with respect to a specific time element of the frame:
determining a number of bits required for entropy coding differences between the quantized frequency elements for a first and second entropy coding parameters;
determining a number of bits required for entropy coding differences between the quantized time elements for the first and second entropy coding parameters;
selecting, for the specific time element, the first entropy coding parameter or the second entropy coding parameter based on a smaller number of bits required for coding the differences in the specific time element of the frame; and
selecting one of the entropy coding of the differences between frequency elements or time elements for the selected first entropy coding parameter or the second entropy coding parameter based entropy coding based on a smaller number of bits required for coding the differences in the specific time element of the frame.

10. The apparatus as claimed in claim 9, wherein the apparatus is caused to encode the selected sub-set of the integer representations of the ratio parameter value for the subsequent groupings as difference values with respect to the first grouping or first set of groupings by encoding the selected one of the entropy coding of the differences between frequency elements or time elements for the selected first entropy coding parameter or the second entropy coding parameter based entropy coding.

11. The apparatus as claimed in claim 1, wherein the apparatus is caused to encode the selected sub-set of the integer representations of the ratio parameter value for the subsequent groupings as difference values with respect to the first grouping or first set of groupings by:
performing with respect to a set of selection of ratio parameters with respect to a specific frequency element of the frame:
determining a number of bits required entropy coding quantized differences between frequency elements for a first and second entropy coding parameters;
determining a number of bits required entropy coding quantized differences between time elements for the first and second entropy coding parameters;
selecting, for the specific frequency element, the first entropy coding parameter or the second entropy coding parameter based on a smaller number of bits required for coding the differences in the specific time element of the frame; and
selecting, for the specific frequency element, one of the entropy coding of differences between frequency elements or time elements for the selected first entropy coding parameter or the second entropy coding parameter based entropy coding based on a smaller number of bits required for coding the differences in the specific time element of the frame.

12. The apparatus as claimed in claim 11, wherein the apparatus is caused to encode the selected sub-set of the integer representations of the ratio parameter value for the subsequent groupings as difference values with respect to the first grouping or first set of groupings by encoding the selected one of the entropy coding of the differences between frequency elements or time elements for the selected first entropy coding parameter or the second entropy coding parameter based entropy coding.

13. The apparatus as claimed in claim 8, wherein the apparatus is caused to encode the selected sub-set of the integer representations of the ratio parameter value for the subsequent groupings as difference values with respect to the first grouping or first set of groupings by:
generating an indicator indicating the selected first entropy coding parameter or the second entropy coding parameter; and
generating an indicator indicating the selected one of the entropy coding of differences between frequency elements or time elements for the selected first entropy coding parameter or the second entropy coding parameter based entropy coding.

14. The apparatus as claimed in claim 8, wherein the entropy coding is Golomb-Rice entropy coding and the first entropy coding parameter is a Golomb-Rice entropy coding order 0 and the second entropy coding parameter is a Golomb-Rice entropy coding order 1.

15. The apparatus as claimed in claim 8, wherein the apparatus is caused to encode the selected sub-set of the integer representations of the ratio parameter value for the subsequent groupings as difference values with respect to the first grouping or first set of groupings by differential encoding of the selection of ratio parameters based on the precedingly indexed time element grouping of ratio parameters where there is no precedingly indexed frequency element grouping of ratio parameters.

16. The apparatus as claimed in claim 1, wherein the ratio parameters configured to identify a distribution of a specific object within the object part of the total audio environment are ISM ratios.

17. The apparatus as claimed in claim 1, wherein the apparatus is caused to select a sub-set of the integer representations of the ratio parameter values for the subsequent groupings by further:
determining the integer representations of the ratio parameter value associated with the selected one of the at least two audio objects to be encoded separately is substantially zero for all frequency elements of the first grouping or first set of groupings; and
encoding only the remaining selected sub-set of the integer representations of the ratio parameter value for the subsequent groupings as difference values with respect to the first grouping or first set of groupings.

18. The apparatus as claimed in claim 1, wherein the first grouping is a grouping of a first time and frequency element of the groupings and the first set of groupings are groupings of frequency element groupings associated with the first time element.

19. The apparatus as claimed in claim 1, wherein the apparatus is further caused to encode the identified one of the at least two audio objects separately.

20. An apparatus for decoding audio object parameters, the apparatus comprising at least one processor and at least one memory storing instructions that, when executed by the at least one processor, cause the apparatus at least to perform:
obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio objects and the ratio parameters configured to identify a distribution of a specific object within the object part of the total audio environment and for a specific time-frequency element;
identifying one of at least two audio objects within the audio environment has been encoded separately;
decoding enumeration indexes within a first grouping or first set of groupings to generate decoded integer representations of the ratio parameter values for the first grouping or first set of groupings; and
decoding subsequent groupings as difference values with respect to the first grouping or first set of groupings, wherein the apparatus is caused to decode subsequent groupings by further:
determining with respect to the subsequent groupings a further ratio parameter value based on a difference between a defined total ratio value and a sum of the ratio values within the grouping.

21. The apparatus as claimed in claim 20, wherein the apparatus is caused to decode subsequent groupings as difference values with respect to the first grouping or first set of groupings by further:
determining that the ratio parameter value corresponding to the one of at least two audio objects within an audio environment encoded separately is zero for all frequency elements of the first time element; and
determining with respect to the subsequent groupings an additional ratio parameter value with a value of zero representing the one of at least two audio objects within an audio environment encoded separately.

22. The apparatus as claimed in claim 20, wherein the grouping is a vector of the ratio parameters.

23. The apparatus as claimed in claim 20, wherein the apparatus is caused to decode enumeration indexes within a first grouping or first set of groupings to generate decoded integer representations of the ratio parameter values for the first grouping or first set of groupings by:
obtaining an integer value representing encoded ratio parameters;
converting the integer value to a selection of ratio parameters based on the indexing of the vector; and
regenerating at least one further ratio parameter from the selection of the ratio parameters.

24. The apparatus as claimed in claim 20, wherein the apparatus is caused to decode subsequent groupings as difference values with respect to the first grouping or first set of groupings by:
obtaining a difference indicator identifying a frequency difference or time difference encoding;
obtaining an entropy encoding indicator identifying an entropy encoding parameter; and
decoding the remaining selection of the ratio parameters for the frame based on the difference indicator and the entropy encoding indicator.

25. The apparatus as claimed in claim 20, wherein the ratio parameters configured to identify a distribution of a specific object within the object part of the total audio environment are ISM ratios.

26. A method for encoding audio object parameters, the method comprising:
identifying one of at least two audio objects within an audio environment to be encoded separately;
obtaining, for time-frequency elements of a frame comprising at least one time element and at least one frequency element, ratio parameters for the at least two audio objects, the ratio parameters configured to identify a distribution of a specific audio object within an object part of the total audio environment and for a specific time-frequency element;
grouping, for the time-frequency elements, ratio parameters associated with the at least two audio objects,
quantizing the ratio parameters within the grouping, wherein the quantizing the ratio parameters is configured to generate integer representations of the ratio parameter values which sum for a specific grouping to a defined integer value;
encoding the integer representations of the ratio parameter values within a first grouping or first set of groupings as enumeration indexes;
encoding subsequent groupings as difference values with respect to the first grouping or first set of groupings, wherein the encoding subsequent groupings further comprises:
selecting a sub-set of the integer representations of the ratio parameter values for the subsequent groupings; and
encoding the selected sub-set of the integer representations of the ratio parameter value for the subsequent groupings as difference values with respect to the first grouping or first set of groupings,
wherein grouping further comprises ordering the ratio parameters within the grouping such that the selected sub-set of the integer representations of the ratio parameter value comprises the integer representations of the ratio parameter value associated with the selected one of the at least two audio objects to be encoded separately.

27. The method as claimed in claim 26, wherein selecting a sub-set of the integer representations of the ratio parameter values for the subsequent groupings further comprises selecting all but one of the integer representations for a specific grouping, as the integer representations of the ratio parameter values for the grouping is a defined value for every grouping.

28. The method as claimed in claim 26, wherein selecting a sub-set of the integer representations of the ratio parameter values for the subsequent groupings further comprises:
determining that the integer representation of the ratio parameter value corresponding to the one of at least two audio objects within an audio environment to be encoded separately is zero for all frequency elements of the first time element; and
selecting all but two of the integer representations for a specific grouping, wherein the selecting does not include the integer representation of the ratio parameter value corresponding to the one of at least two audio objects within an audio environment to be encoded separately.

29. A method for decoding audio object parameters, the method comprising:
obtaining a bitstream comprising encoded integer representations of ratio parameters, for time-frequency elements of a frame comprising at least one time element and at least one frequency element, the integer representations of ratio parameters associated with audio objects within an audio environment, the audio environment comprising more than two audio object and the ratio parameters configured to identify a distribution of a specific object within the object part of the total audio environment and for a specific time-frequency element;
identifying one of at least two audio objects within the audio environment has been encoded separately;
decoding enumeration indexes within a first grouping or first set of groupings to generate decoded integer representations of the ratio parameter values for the first grouping or first set of groupings; and
decoding subsequent groupings as difference values with respect to the first grouping or first set of groupings, wherein decoding subsequent groupings further comprises determining with respect to the subsequent groupings a further ratio parameter value based on a difference between a defined total ratio value and a sum of the ratio values within the grouping.

30. The method as claimed in claim 29, wherein decoding subsequent groupings as difference values with respect to the first grouping or first set of groupings comprises:
determining that the ratio parameter value corresponding to the one of at least two audio objects within an audio environment encoded separately is zero for all frequency elements of the first time element; and
determining with respect to the subsequent groupings an additional ratio parameter value with a value of zero representing the one of at least two audio objects within an audio environment encoded separately.
